(19) United States
(12) Patent Application Publication
(10) Pub. No.: US 2025/0353970 A1
(43) Pub. Date: Nov. 20, 2025

(54) POLYMERIC COMPOSITIONS AND PRODUCTS OF LOW WEAR AND OF LOW FRICTION

(71) Applicant: W. L. Gore & Associates, Inc., Newark, DE (US)

(72) Inventors: Ravi Gupta, Elkton, MD (US); Edward A. Sabol, Newark, DE (US); Gregory J. Shafer, Oxford, PA (US); Paul Smith, Klosters (CH); Aadil Elmoumni, Middletown, DE (US)

(21) Appl. No.: 19/213,756

(22) Filed: May 20, 2025

Related U.S. Application Data
(60) Provisional application No. 63/649,785, filed on May 20, 2024.
(60) Provisional application No. 63/808,319, filed on May 19, 2025.

(51) Int. Cl. C08G 77/52

(52) U.S. Cl. CPC C08G 77/52

(57) ABSTRACT

Polymeric compositions, products and articles having low friction and low wear, and in particular polymeric products, articles and composites including poly(tetramethyl-p-silphenylenesiloxane). Methods of making the polymeric compositions, products, and articles are also disclosed.

### CROSS-REFERENCE TO RELATED APPLICATION

This application claims the benefit of Provisional Application No. 63/649,785, filed May 20, 2024, and claims the benefit of Provisional Application No. 63/808,319, filed May 19, 2025, which are incorporated herein by reference in their entireties for all purposes.

### FIELD

The present invention relates to polymeric compositions and products and articles having low friction and low wear, and methods of making same, and in particular polymeric products, articles and composites including poly(tetramethyl-p-silphenylenesiloxane).

### BACKGROUND

It is generally appreciated that friction and wear occur during use of virtually all parts, articles and objects, especially where any kind of motion is involved. Low friction is desirable to reduce energy consumption, provide smooth and reproducible motion, reduce noise, as well as reduce wear. Similarly, low wear may be desirable because it may prevent the production of particulates, i.e., wear debris, thereby increasing the lifetime of parts, articles and objects.

Reduced friction may be achieved by lubrication of surfaces with substances such as oils, water, surfactants, liquid crystals, greases, waxes, and additives, such as mica, graphite or talc.

Thus, there exists a need in the art for a non-fluoropolymer article that at least demonstrates the positive attributes that fluoropolymers demonstrate.

### SUMMARY

The present disclosure provides polymeric compositions and products, which include polysiloxane polymers such as poly(tetramethyl-p-silphenylenesiloxane) (PTMPS). Advantageously, the compositions and products have the unusual combination of low friction and low wear rate.

Surprisingly, it has been found that non-fluorinated polymeric materials according to the present disclosure can exhibit a coefficient of friction (also referred to as friction coefficient, COF, CoF, μ) less than 0.05. The materials of the present disclosure may also exhibit a combination of low friction and low rates of wear, expressed in the form of the product of the friction coefficient μ and the rate of wear κ, i.e., μ×κ of less than 4×10⁻⁶ mm³/mN.

In a first example, the present disclosure provides a polymer composition comprising a siloxane polymer with repeat units of the following general Formula 3:

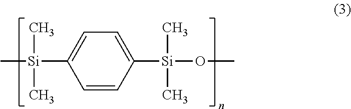

wherein n is any integer from 5 to 50,000; and
wherein the polymer composition comprises an amount of oligomers having a molecular weight of less than 20,000 Da of from 0.1% to 10% as determined by gel permeation chromatography.

In a second example, the present disclosure provides a polymer composition comprising a siloxane polymer with repeat units of the following general Formula 3:

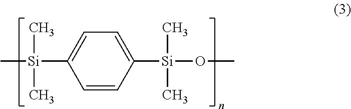

wherein n is any integer from 40 to 50,000 Da and
wherein the siloxane polymer has a molecular weight polydispersity of less than or equal to 10.

In a third example, the present disclosure provides a polymer composition comprising a siloxane polymer with repeat units of the following general Formula 3:

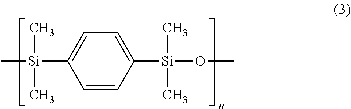

wherein n is any integer from 40 to 50,000,
wherein the polymer composition comprises an amount of oligomers having a molecular weight of less of from 450 to 20,000 Da of from 0.1% to 10% as determined by gel permeation chromatography; and
wherein the siloxane polymer has a molecular weight polydispersity of less than or equal to 10.

In a fourth example, the present disclosure provides a polymer composition comprising a siloxane polymer with repeat units of the following general Formula 1:

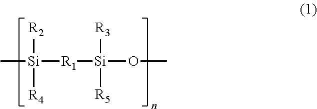

wherein R₁, R₂, R₃, R₄, and R₅ may be the same or different at each instance and are selected from alkyl groups having 1 to 20 carbon atoms, branched or cyclic alkyl groups having 3 to 20 carbon atoms, alkenyl or alkynyl groups having 2 to 20 carbon atoms, aromatic ring systems having 6 to 40 aromatic ring atoms, and heteroaromatic ring systems having 5 to 40 aromatic ring atoms;
wherein n is any integer from 2 to 100,000; and
wherein the polymer composition comprises an amount of oligomers having a molecular weight from 450 Da to 20,000 Da of from 0.1% to 4% as determined by gel permeation chromatography.

In a fifth example, the present disclosure provides a method for preparing a polymer composition comprising:
(i) polymerizing monomers of the general Formula (4) to form a polymer:

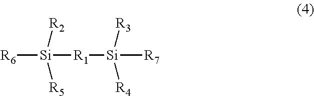

wherein R₁, R₂, R₃, R₄, and R₅ may be the same or different at each instance and are selected from alkyl groups having 1 to 20 carbon atoms, branched or cyclic alkyl groups having 3 to 20 carbon atoms, alkenyl or alkynyl groups having 2 to 20 carbon atoms, aromatic ring systems having 6 to 40 aromatic ring atoms, and heteroaromatic ring systems having 5 to 40 aromatic ring atoms;
wherein R₆ and R₇ may be the same or different at each instance and are selected from hydroxyl groups, alkoxy groups, hydrogen, and halogens; and
(ii) immersing the polymer from step (i) in a solvent to remove oligomers from the polymer.

In a sixth example, the present disclosure provides a method for preparing a polymer composition comprising:
(i) polymerizing monomers of the general Formula (5) to form a polymer:

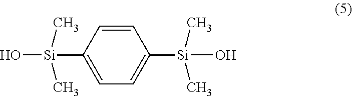

(ii) immersing the polymer from step (i) in a solvent to remove oligomers from the polymer.

In a seventh example, the present disclosure provides a polymer composition comprising a siloxane polymer with repeat units of the following general Formula (3):

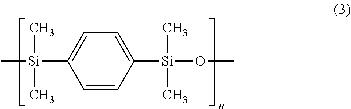

wherein n is any integer from 40 to 50,000, and
wherein the siloxane polymer provides a constant average coefficient of friction over a time period of sixty minutes of wear testing,
wherein the coefficient of friction is measured using a pin-on-disk test against Si₃N₄ at room temperature for a period of 1 hr at a sliding speed of 1 mm/s, a sliding distance of 14 mm, a rotation of 1 rpm and a static pressure of 15 N using a tribometer, such as that available from Bruker under the trade name “UMT TRIBOLAB” Mechanical Tester and Tribometer.

The foregoing examples are just that and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is a graph showing the coefficients of friction (COF, y-axis) for various polymers as a function of a testing time of 1 hour. The graph in FIG. 1 is to the scale shown in FIG. 1.

FIG. 2A is an image showing the surface wear of a poly(tetramethyl-p-silphenylenesiloxane) polymer including 100 wt. % of a 287,000 Da polymer with 5 N of normal force. The graph in FIG. 2A is to the scale shown in FIG. 2A.

FIG. 2B is a graph showing the wear profile of a poly(tetramethyl-p-silphenylenesiloxane) polymer including 100 wt. % of a 287,000 Da polymer with 5 N of normal force. The graph in FIG. 2B is to the scale shown in FIG. 2B.

FIG. 2C shows the level of particulation on the Si₃N₄ countersurface after measuring the wear of a poly(tetramethyl-p-silphenylenesiloxane) polymer including 100 wt. % of a 287,000 Da polymer with 5 N of normal force. The graph in FIG. 2C is to the scale shown in FIG. 2C.

FIG. 2D is an image showing the surface wear of a poly(tetramethyl-p-silphenylenesiloxane) polymer including 90 wt. % of a 287,000 Da polymer and 10 wt. % of a 26,000 Da polymer with 5 N of normal force. The graph in FIG. 2D is to the scale shown in FIG. 2D.

FIG. 2E is a graph showing the wear profile of a poly(tetramethyl-p-silphenylenesiloxane) polymer 90 wt. % of a 287,000 Da polymer and 10 wt. % of a 26,000 Da polymer with 5 N of normal force. The graph in FIG. 2E is to the scale shown in FIG. 2E.

FIG. 2F shows the level of particulation on the Si₃N₄ countersurface after measuring the wear of a poly(tetramethyl-p-silphenylenesiloxane) polymer including 90 wt. % of a 287,000 Da polymer and 10 wt. % of a 26,000 Da polymer with 5 N of normal force. The graph in FIG. 2F is to the scale shown in FIG. 2F.

FIG. 2G is an image showing the surface wear of a poly(tetramethyl-p-silphenylenesiloxane) polymer including 50 wt. % of a 287,000 Da polymer and 50 wt. % of a 26,000 Da polymer with 5 N of normal force. The graph in FIG. 2G is to the scale shown in FIG. 2G.

FIG. 2H is a graph showing the wear profile of a poly(tetramethyl-p-silphenylenesiloxane) polymer 50 wt. % of a 287,000 Da polymer and 50 wt. % of a 26,000 Da polymer with 5 N of normal force. The graph in FIG. 2H is to the scale shown in FIG. 2H.

FIG. 2I shows the level of particulation on the Si₃N₄ countersurface after measuring the wear of a poly(tetramethyl-p-silphenylenesiloxane) polymer including 50 wt. % of a 287,000 Da polymer and 50 wt. % of a 26,000 Da polymer with 5 N of normal force. The graph in FIG. 2I is to the scale shown in FIG. 2I.

FIG. 3A is an image showing the surface wear of a poly(tetramethyl-p-silphenylenesiloxane) polymer including 100 wt. % of a 287,000 Da polymer with 10 N of normal force. The graph in FIG. 3A is to the scale shown in FIG. 3A.

FIG. 3B is a graph showing the wear profile of a poly(tetramethyl-p-silphenylenesiloxane) polymer including 100 wt. % of a 287,000 Da polymer with 10 N of normal force. The graph in FIG. 3B is to the scale shown in FIG. 3B.

FIG. 3C shows the level of particulation on the Si₃N₄ countersurface after measuring the wear of a poly(tetramethyl-p-silphenylenesiloxane) polymer including 100 wt. % of a 287,000 Da polymer with 10 N of normal force. The graph in FIG. 3C is to the scale shown in FIG. 3C.

FIG. 3D is an image showing the surface wear of a poly(tetramethyl-p-silphenylenesiloxane) polymer including 90 wt. % of a 287,000 Da polymer and 10 wt. % of a 26,000 Da polymer with 10 N of normal force. The graph in FIG. 3D is to the scale shown in FIG. 3D.

FIG. 3E is a graph showing the wear profile of a poly(tetramethyl-p-silphenylenesiloxane) polymer 90 wt. % of a 287,000 Da polymer and 10 wt. % of a 26,000 Da polymer with 10 N of normal force. The graph in FIG. 3E is to the scale shown in FIG. 3E.

FIG. 3F shows the level of particulation on the Si₃N₄ countersurface after measuring the wear of a poly(tetramethyl-p-silphenylenesiloxane) polymer including 90 wt. % of a 287,000 Da polymer and 10 wt. % of a 26,000 Da polymer with 10 N of normal force. The graph in FIG. 3F is to the scale shown in FIG. 3F.

FIG. 3G is an image showing the surface wear of a poly(tetramethyl-p-silphenylenesiloxane) polymer including 50 wt. % of a 287,000 Da polymer and 50 wt. % of a 26,000 Da polymer with 10 N of normal force. The graph in FIG. 3G is to the scale shown in FIG. 3G.

FIG. 3H is a graph showing the wear profile of a poly(tetramethyl-p-silphenylenesiloxane) polymer 50 wt. % of a 287,000 Da polymer and 50 wt. % of a 26,000 Da polymer with 10 N of normal force. The graph in FIG. 3H is to the scale shown in FIG. 3H.

FIG. 3I shows the level of particulation on the Si₃N₄ countersurface after measuring the wear of a poly(tetramethyl-p-silphenylenesiloxane) polymer including 50 wt. % of a 287,000 Da polymer and 50 wt. % of a 26,000 Da polymer with 10 N of normal force. The graph in FIG. 3I is to the scale shown in FIG. 3I.

FIG. 3J is an SEM image showing a transfer layer adhered to the Si₃N₄ countersurface after measuring the wear of a poly(tetramethyl-p-silphenylenesiloxane) polymer including 100 wt. % of a 650,000 Da polymer with 10 N of normal force. The graph in FIG. 3J is to the scale shown in FIG. 3J.

FIG. 3K is an SEM image showing the level of particulation on the Si₃N₄ countersurface after measuring the wear of an ultra-high molecular weight polyethylene polymer including 100 wt. % of a 2,063,000 Da polymer with 10 N of normal force. The graph in FIG. 3K is to the scale shown in FIG. 3K.

FIG. 4A is a graph showing the coefficients of friction (COF, y-axis) for a poly(tetramethyl-p-silphenylenesiloxane) polymer including 100 wt. % of a 3,300,000 Da polymer and an ultra-high molecular weight polyethylene polymer including 100 wt. % of a 2,063,000 Da polymer as a function of a testing time of 60 hours. The graph in FIG. 4A is to the scale shown in FIG. 4A.

FIG. 4B is an image showing the surface wear of a poly(tetramethyl-p-silphenylenesiloxane) polymer including 100 wt. % of a 3,300,000 Da polymer with 10 N of normal force after a pin-on-disk test against a stainless steel ball. The graph in FIG. 4B is to the scale shown in FIG. 4B.

FIG. 4C is an image showing the surface wear of an ultra-high molecular weight polyethylene polymer including 100 wt. % of a 2,063,000 Da polymer with 10 N of normal force after a pin-on-disk test against a stainless steel ball. The graph in FIG. 4C is to the scale shown in FIG. 4C.

FIG. 5A is an image showing a transfer layer adhered to a hardened steel countersurface after measuring the wear of a poly(tetramethyl-p-silphenylenesiloxane) polymer including 100 wt. % of a 400,000 Da polymer.

FIG. 5B is an image showing the surface wear of a poly(tetramethyl-p-silphenylenesiloxane) polymer including 100 wt. % of a 400,000 Da polymer after a block-on-disk test.

FIG. 6A is an image showing a hardened steel countersurface after measuring the wear of ultra-high molecular weight polyethylene polymer including 100 wt. % of a 2,063,000 Da polymer.

FIG. 6B is an image showing the surface wear of an ultra-high molecular weight polyethylene polymer including 100 wt. % of a 2,063,000 Da polymer after a block-on-disk test.

FIGS. 7A-7C are schematic diagrams of a block-on-disk test conducted using a hardened steel countersurface against a poly(tetramethyl-p-silphenylenesiloxane) polymer described herein. FIGS. 8A-8C are schematic diagrams of a block-on-disk test conducted using a hardened steel countersurface against an ultra-high molecular weight polyethylene polymer.

FIG. 9A is a profile curve of a clean hardened steel countersurface used in a block-on-disk test. The graph in FIG. 9A is to the scale shown in FIG. 9A.

FIG. 9B is an Abbott-Firestone curve of the clean hardened steel countersurface in FIG. 9A. The graph in FIG. 9B is to the scale shown in FIG. 9B.

FIG. 10A is a profile curve of a hardened steel countersurface used in a block-on-disk test against a poly(tetramethyl-p-silphenylenesiloxane) polymer including 100 wt. % of a 3,300,000 Da polymer. The graph in FIG. 10A is to the scale shown in FIG. 10A.

FIG. 10B is an Abbott-Firestone curve of the hardened steel countersurface in FIG. 10A. The graph in FIG. 10B is to the scale shown in FIG. 10B.

FIG. 11A is a profile curve of a hardened steel countersurface used in a block-on-disk test against an ultra-high molecular weight polyethylene polymer including 100 wt. % of a 2,063,000 Da polymer. The graph in FIG. 11A is to the scale shown in FIG. 11A.

FIG. 11B is an Abbott-Firestone curve of the hardened steel countersurface in FIG. 11A. The graph in FIG. 11B is to the scale shown in FIG. 11B.

FIG. 12 is a surface wear contour plot showing the specific surface wear of a poly(tetramethyl-p-silphenylenesiloxane) polymer including 100 wt. % of a 400,000 Da polymer after a block-on-disk test. The graph in FIG. 12 is to the scale shown in FIG. 12.

FIG. 13 is a surface wear contour plot showing the specific surface wear of a poly(tetramethyl-p-silphenylenesiloxane) polymer including 100 wt. % of a 3,300,000 Da polymer after a block-on-disk test. The graph in FIG. 13 is to the scale shown in FIG. 13.

FIG. 14 is a surface wear contour plot showing the specific surface wear of an ultra-high molecular weight polyethylene polymer including 100 wt. % of a 2,063,000 Da polymer using a block-on-disk test. The graph in FIG. 14 is to the scale shown in FIG. 14.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably minor differences, the terms “about” and “approximately” can be understood to mean plus or minus 10% of the stated value.

As used herein the term “PTMPS” means poly(tetramethyl-p-silphenylenesiloxane).

As used herein, the term “wear rate”, κ in mm³/mN is defined as follows: κ=V/SN, where V is the wear volume, S the sliding distance and N the normal force.

As used herein, the term “specific wear rate” is calculated by dividing a change in laser displacement measurement by a change in sliding distance. As used herein, a specific wear rate is categorized as follows: 0-10 nm/m (Excellent), 10-30 nm/m (Moderate), 50-100 nm/m (Severe), >100 nm/m (Catastrophic).

The wear coefficient α is the product of the friction coefficient μ times the wear rate, κ, mm³/mN:

α=μ·κ

As used herein, the term coefficient of friction (COF), μ, is measured by engaging a material frictionally against a countersurface under a certain load and/or velocity. COF as used herein may be calculated by dividing the measured friction force by the normal load applied.

As used herein, the term “chain characteristic ratio” refers to the ratio of the observed end-to-end distance to the end-to-end distance of a freely jointed polymer chain with the same number of main chain bonds.

As used herein, the term “raw polymer” or “raw PTMPS polymer” refers to the polymer straight out of the reactor and converted into an article.

As used herein, the term “finished polymer” or “finished PTMPS polymer” refers to the polymer which has been further processed from the raw stage to remove low molecular weight species including monomer and oligomers.

As used herein, the term “copolymer” refers to any polymer containing more than 0.001% by weight of at least one comonomer.

As used herein, the term “Abbott-Firestone curve” refers to a graph generated by plotting a cumulative probability density function of a surface profile's height that shows the percentage of a surface's material that would contact a flat plane as it moves from the highest peak down through the profile. It analyses roughness and texture, helping evaluate functional traits of a material (e.g., polymeric material).

As used herein, the term “Surface Kurtosis (Rku)” is the fourth central moment of the surface-height distribution on an Abbott-Firestone Curve, normalized by the square of its second central moment (variance). An Rku value of 3 means that the height distribution is Gaussian. An Rku value larger than 3 means there are “heavy tails” or sharp peaks and valleys dominating the profile, indicating potential for high local contact stresses. An Rku value less than 3 means “light tails” or a more plateau-like profile with fewer extreme peaks/dips. The Rku value for a set of zero-mean heights zi is represented below in Equation 1:

$${R}_{ku} = \frac{\frac{1}{N} {\sum }_{i = 1}^{N} {z}_{i}^{4}}{{( \frac{1}{N} {\sum }_{i = 1}^{N} {z}_{i}^{4} )}^{2}} \qquad ( Equation 1 )$$

Persons skilled in the art will readily appreciate that various aspects of the present disclosure can be realized by any number of methods and apparatuses configured to perform the intended functions.

### Polymers and Polymer Compositions

In general, the polysiloxane polymers disclosed herein may contain a repeat unit of Formula 1:

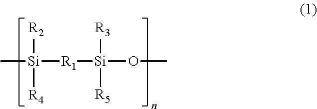

wherein R₁, R₂, R₃, R₄, and R₅ may be the same or different at each instance and are selected from alkyl groups having 1 to 20 carbon atoms, branched or cyclic alkyl groups having 3 to 20 carbon atoms, alkenyl or alkynyl groups having 2 to 20 carbon atoms, aromatic ring systems having 6 to 40 aromatic ring atoms, and heteroaromatic ring systems having 5 to 40 aromatic ring atoms;
wherein n may be an integer from 2 to 100,000, or 5 to 50,000, or 40 to 50,000 or 50 to 50,000 or 100 to 30,000, 200 to 25,000, or 300 to 3800, or 50 to 250, or any integer within any of the foregoing ranges.

In other exemplary embodiments, the polysiloxane polymers disclosed herein may contain a repeat unit of the general Formula 2:

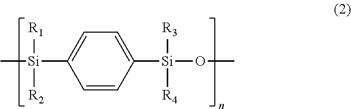

In Formula 2, the substituents R₁, R₂, R₃, and R₄, may be the same or different at each instance and are selected from alkyl groups having 1 to 20 carbon atoms, branched or cyclic alkyl groups having 3 to 20 carbon atoms, alkenyl or alkynyl groups having 2 to 20 carbon atoms, aromatic ring systems having 6 to 40 aromatic ring atoms, and heteroaromatic ring systems having 5 to 40 aromatic ring atoms;
wherein n may be an integer from 2 to 100,000, or 5 to 50,000, or 40 to 50,000 or 50 to 50,000 or 100 to 30,000, 200 to 25,000, or 300 to 3800, or 50 to 250, or any integer within any of the foregoing ranges.

In some embodiments, the polysiloxane polymers disclosed herein may contain a repeat unit of Formula (3):

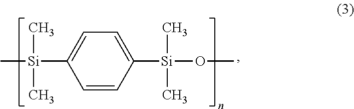

wherein n may be an integer from 2 to 100,000; or 50 to 50,000 or 100 to 30,000, 200 to 25,000, or 300 to 3800.

In some embodiments, the polysiloxane polymers may contain units of at least one other comonomer, that is, other than repeat unit of the general Formula (1). A comonomer may be an ethylenically unsaturated monomer having a sufficiently high reactivity ratio to the repeat unit of the general Formula 1 to enable polymerization therewith. For example, the comonomer may be an alkyl, aromatic or aryl silanols, amines, carboxylic acids or any other monomers suitable for a condensation reaction, for example m-bis(dimethylhydroxysilyl)benzene, or o-bis(dimethylhydroxysilyl)benzene.

Comonomers may be present in the polysiloxane polymer in an amount greater than 0.001 mol %, greater than 1 mol %, greater than 5 mol %, greater than 10 mol %, greater than 15 mol %, or greater than 20 mol %. It some embodiments, the comonomers may be present in the copolymer in an amount from about 0.001 mol % to about 80 mol %, from about 0.001 mol % to about 50 mol %, from about 0.001 mol % to about 30 mol %, from about 0.01 mol % to about 15 mol %, or from about 0.01 mol % to about 10 mol %, from about 0.01 mol % to about 5 mol %, or from about 0.1 mol % to about 1 mol %.

In some embodiments, the polysiloxane polymers may have a weight average molecular weight in Daltons (Da) of as low as about 1,000 Da, about 5,000 Da, about 10,000 Da, about 15,000 Da, about 20,000 Da, about 30,000 Da, about 50,000 Da, about 100,000 Da, about 250,000 Da, about 500,000 Da, about 750,000 Da, about 1,000,000 Da, about 1,250,000 Da, or as high as about 1,500,000 Da, about 1,750,000 Da, about 2,000,000 Da, about 3,000,000 Da, about 4,000,000 Da, about 5,000,000 Da, about 6,000,000 Da, about 10,000,000 Da, or within any range encompassed by any two of the foregoing values as endpoints. For example, the polymers may have a weight average molecular weight of from about 10,000 Da to about 1,000,000 Da, from about 30,000 Da to about 6,000,000 Da, from about 30,000 Da to about 5,000,000 Da, from about 30,000 Da to about 4,000,000 Da, from about 30,000 Da to about 500,000 Da, from about 100,000 Da to about 5,000,000 Da, or from about 250,000 Da to about 4,000,000 Da.

In some embodiments, the polymers may have a number average molecular weight of as low as about 1,000 Da, about 5,000 Da, about 10,000 Da, about 25,000 Da, about 50,000 Da, about 100,000 Da, about 200,000 Da, about 250,000 Da, about 500,000 Da, about 750,000 Da, about 1,000,000 Da, about 1,250,000 Da, about 1,500,000 Da, about 1,750,000 Da, about 2,000,000 Da, about 2,500,000 Da, about 3,000,000 Da, about 4,000,000 Da, about 5,000,000 Da, or within any range encompassed by any two of the foregoing values as endpoints. For example, the polymers may have a number average molecular weight of from about 1,000 Da to about 4,000,000 Da, from about 50,000 Da to about 2,000,000 Da, from about 100,000 Da to about 1,500,000 Da, or from about 250,000 Da to about 1,000,000 Da.

In some embodiments, the polymers have a polydispersity (weight average-divided by number average molecular weight) of between about 1 to about 5, between about 1.2 and about 4, or between about 1.5 and about 3.

In some embodiments, the polymers may have a chain characteristic ratio, defined as the ratio of the length of actual end-to-end distance of the real polymer chain compared to a hypothetical ideal chain with (statistical) bond length, of less than 10, less than 9, less than 8, less than 7, less than 6, less than 5, less than 4, less than 3, or less than 2.

In some embodiments, the polysiloxane polymer in the composition may have a molecular weight of a weight average molecular weight of from about 10,000 Da to about 1,000,000 Da, from about 30,000 Da to about 6,000,000 Da, from about 30,000 Da to about 5,000,000 Da, from about 30,000 Da to about 4,000,000 Da, from about 30,000 Da to about 500,000 Da, from about 100,000 Da to about 5,000,000 Da, or from about 250,000 Da to about 4,000,000 Da.

In some embodiments, the polymer compositions may further include a filler material. Suitable filler materials for instance may serve to enhance, among others, mechanical, electrical, acoustic, insulating and optical properties. Nonlimiting examples of suitable filler materials may include inorganic materials, silica, carbon black, aerogels, metals, semi-metals, ceramics, carbon/metal particulate blends, activated carbon, hydrogel materials, bioactive substances, stiffening agents, reinforcing matter including high-performance films and fibers such as those of aramids, ultra-high molecular weight polyethylene (UHMWPE), glass, carbon, and combinations thereof. Alternatively, suitable non-reactive filler materials may be incorporated into the siloxane polymer articles during the formation of the polymer.

The filler materials may be incorporated into the polymer compositions in amounts from about 0.001% to about 99%, or from about 1% to about 90%, or from about 5% to about 75%, or from about 10% to about 50% by weight.

In some embodiments, the polymer composition may further include a second polymer or oligomer, different from the siloxane polymer of Formula (1), (2), or (3). Nonlimiting examples of such polymers may include polyethylene, polypropylene, polyesters, polyamide, polyacrylates, polystyrene, and polyurethanes. The second polymer or oligomer may be a homopolymer, or in some embodiments, may be a copolymer. In some embodiments, the polymer composition may include two or more polymers.

In some embodiments, the polymer composition further includes a crosslinker. The crosslinker may include an epoxy functionality that may include a glycidyl copolymer, such as glycidyl methacrylate, glycidyl esters, such as glycidyl acrylate, and silane coupling agents such as glycidoxyalkyl alkoxysilanes, polyfunctional isocyanates, polyfunctional amines, polyfunctional alcohols, and polyfunctional acrylates. In some embodiments, the cross-linker may be based on a polyfunctional isocyanate, a glycidyl amine, or a multi-functional glycidyl ether. In some embodiments, the crosslinker may be a vinyl silanol, trialkoxysiloxane, silanol tetraalkoxysilane, tetraethoxysilane, silane, or silanol.

In some embodiments, the polysiloxane polymer may have a low level of entanglement. As used herein, “entanglement” refers to the number of physical cross-linking points produced in a polymer chain, or between polymer chains, that make the polymer chains unable to move freely.

In some embodiments, the polymer compositions may have a low level of crystallinity. In some embodiments, the polymer compositions may have a crystallinity of about 10% or greater, about 20% or greater, about 30% or greater, about 40% or greater, about 50% or greater, about 60% or greater, or about 65% or greater, or about 70% or greater, or about 75% or greater, or about 80% or greater, or about 85% or greater, or about 90% or greater, or about 99% or greater. In some embodiments, the polymeric materials have a crystallinity of between about 10% and about 99%, between about 20% and 80%, between about 40% and 70%, or between about 65% and about 95%.

In some embodiments, management of thermal processes during fabrication can affect crystallinity to generate a greater presence of crystal structures at a surface of the embodiment as compared to an interior of the embodiment. That variance between surface crystallinity and interior crystallinity can be expressed as a ratio of surface:interior ranging from broad ranges of 1.1:1-10:1 or narrower range of 2:1-7:1, or more narrower ranges of 2:1-5:1 and 5:1-7:1, or even more narrower ranges of 1.1:2, 2:1-3:1, 3:1-4:1, 4:1-5:1, 5:1-6:1, 6:1-7:1, 7:1-8:1, 8:1-9:1, and 9:1-10:1. Comonomers may be present in the copolymer in an amount from about 0.001 mol % to about 10 mol %, from about 0.01 mol % to about 5 mol %, from about 0.1 mol % to about 1 mol %, or any other amount encompassed within these endpoints. In certain embodiments, the polymer particles include comonomer in an amount less than about 10 mol %, or less than about 5 mol %, or less than about 1 mol % such that the crystallinity of the polymeric material does not rise above a desired amount (e.g., 60% or higher). The crystallinity of the polymers may be measured by differential scanning calorimetry (DSC), infrared radiation (IR), Raman spectroscopy, Nuclear Magnetic Resonance (NMR) spectroscopy, and/or X-ray Diffraction (XRD).

In some embodiments, the polymer composition may be included in an article. In some embodiments, the article may have a coefficient of friction, u, of less than about 1.0, less than about 0.5, less than about 0.25, less than about 0.1, less than about 0.09, less than about 0.08, less than about 0.07, less than about 0.06, less than about 0.05, less than about 0.04, less than about 0.03, less than about 0.02, or equal to about 0.01. For example, the coefficient of friction may be from about 0.01 to about 1.0, or from about 0.01 to about 0.5, from about 0.01 to about 0.10, or may have any number encompassed by the ranges.

In some embodiments, the polymer compositions provide a coefficient of friction (COF) stable over a time period of sixty hours of wear testing (e.g., using pin-on-disk test against a stainless steel ball). The coefficient of friction may be within a deviation range of ±50% over a time period of about 60 hours during the pin-on-disk test. The deviation range is calculated by subtracting the maximum and/or minimum CoF by the mean value, then divided by the mean value. In some embodiments, the deviation range over a time period of about 60 hours is ±50%, ±45%, ±40%, ±35%, ±30%, ±25%, ±20%, ±15%, ±10%, or within any range encompassing any two of these values as endpoints. In some embodiments, the deviation range over a time period of about 60 hours is from about less than about 50%, less than about 45%, less than about 40%, less than about 35%, less than about 30%, less than about 25%, less than about 20%, or within any range encompassing any two of these values as endpoints. For example, the deviation range over a time period of about 60 hours may be from about 20% to about 50%, or from about 25% to about 45%, or may have any number encompassed by the ranges.

In some embodiments, the polymer compositions provide an average coefficient of friction (COF) over a time period of sixty hours of wear testing (e.g., using pin-on-disk test against a stainless steel ball) of less than about 0.5, less than about 0.25, less than about 0.1, less than about 0.09, less than about 0.08, less than about 0.07, less than about 0.06, less than about 0.05, less than about 0.04, less than about 0.03, less than about 0.02, or equal to about 0.01. For example, the average coefficient of friction over a time period of sixty hours of wear testing may be from about 0.01 to about 0.5, from about 0.02 to about 0.1, from about 0.05 to about 0.08, or may have any number encompassed by the ranges.

In some embodiments, the polymer compositions provide an average coefficient of friction (COF) over a time period of sixty hours of wear testing (e.g., using pin-on-disk test against a stainless steel ball) with a standard deviation of less than about 0.1, less than about 0.09, less than about 0.08, less than about 0.07, less than about 0.06, less than about 0.05, less than about 0.04, less than about 0.03, less than about 0.02, or less than about 0.01. For example, the standard deviation may be from 0.001 to about 0.05, from 0.001 to about 0.02, from 0.001 to about 0.01, or may have any number encompassed by the ranges.

In some embodiments, the polymer compositions provide a specific wear rate determined by wear testing (e.g., block-on-disk test) of less than 30 nm/m, less than 25 nm/m, less than 20 nm/m, less than 15 nm/m, or less than 10 nm/m at a pressure*velocity value of from about 14,000 MPa*mm/s to about 20,000 MPa*mm/s. In some embodiments, for example when the polymer composition includes a PTMPS polymer having a weight average molecular weight is from 1,000,000 Da to 5,000,000 Da, the polymer composition provides a specific wear rate of less than 50 nm/m, less than 45 nm/m, less than 40 nm/m, less than 35 nm/m, or less than 30 nm/m at a pressure*velocity value of from about 200 to about 20,000 MPa*mm/s. In certain embodiments, for example when the polymer composition includes a PTMPS polymer having a weight average molecular weight is from 50,000 Da to 1,000,000 Da, the polymer composition provides a specific wear rate of less than 40 nm/m, less than 35 nm/m, less than 30 nm/m, less than 25 nm/m, or less than 20 nm/m at a pressure*velocity value of from about 12,000 MPa*mm/s to about 20,000 MPa*mm/s. In some embodiments, for example when the polymer composition includes a PTMPS polymer having a weight average molecular weight is from 50,000 Da to 1,000,000 Da, the polymer composition provides a specific wear rate of less than about 40 nm/m, less than about 35 nm/m, or less than about 30 nm/m at a pressure*velocity value of from about 500 MPa*mm/s to about 9,600 MPa*mm/s.

In some embodiments, the article including the polymer composition described herein has a wear coefficient α defined as the product of the friction coefficient μ times the wear rate, K, of less than about 10×10⁻⁶ mm³/mN, less than about 9×10⁻⁶ mm³/mN, less than about 8×10⁻⁶ mm³/mN, less than about 7×10⁻⁶ mm³/mN, less than about 6×10⁻⁶ mm³/mN, less than about 5×10⁻⁶ mm³/mN, less than about 4×10⁻⁶ mm³/mN, less than about 3×10⁻⁶ mm³/mN, less than about 2×10⁻⁶ mm³/mN, or less than about 1×10⁻⁶ mm³/mN. For example, the wear coefficient α may be from about 0.1×10⁻⁶ mm³/mN to about 12×10⁻⁶ mm³/mN, or from about 1×10⁻⁶ mm³/mN to about 8×10⁻⁶ mm³/mN, or from about 4×10⁻⁶ mm³/mN to about 6×10⁻⁶ mm³/mN.

In some embodiments, the polymer compositions, once formed into an article, may have a shore hardness, measured, for example, as Shore D of as low as 45, 50, 55, 60, 65, 70 or as high as 75, 80, 85, 90, 95, or within any range encompassed by any two of the foregoing values as endpoints. For example, the polymer compositions, once formed into an article, may have a shore hardness of from 45 to 95, or from 50 to 80.

### Methods of Making Polymer Compositions

The polymer composition disclosed herein may be prepared by a multi-step process whereby monomers are first (i) polymerized to form a polymer, followed by a cleaning step where the polymer is (ii) immersed in a solvent to remove oligomers from the polymer.

In some embodiments, the polymerization step (i) includes polymerizing monomers of the general Formula (4) to form a polymer:

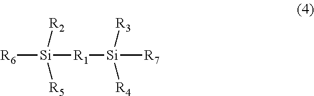

In Formula (4), R₁, R₂, R₃, R₄, and R₅ may be the same or different at each instance and are selected from alkyl groups having 1 to 20 carbon atoms, branched or cyclic alkyl groups having 3 to 20 carbon atoms, alkenyl or alkynyl groups having 2 to 20 carbon atoms, aromatic ring systems having 6 to 40 aromatic ring atoms, and heteroaromatic ring systems having 5 to 40 aromatic ring atoms. R₆ and R₇ may be the same or different at each instance and are selected from hydroxyl groups, alkoxy groups, hydrogen, and halogens.

In Formula (4), n may be an integer from 2 to 100,000, or 5 to 50,000, or 40 to 50,000 or 50 to 50,000 or 100 to 30,000, 200 to 25,000, or 300 to 3800, or 50 to 250, or any integer within any of the foregoing ranges.

In a preferred embodiment, the polymerization step (i) includes polymerizing monomers of the Formula (5), i.e., where R₁ is phenyl and R₂, R₃, R₄, R₅ are methyl and R₆ and R₇ are hydroxyl, to form a polymer:

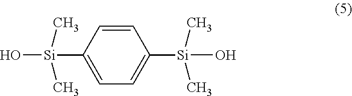

After the polymer is formed, it may be immersed in a solvent in step (ii) to remove oligomers from the polymer.

The solvent may be a hydrocarbon or an organic or inorganic solvent. In some embodiments the solvent may be toluene, xylene, methanol, tetrahydrofuran or benzene.

In some embodiments, the oligomers removed in step (ii) may have a molecular weight of from 450 Da to 10,000 Da, from 1000 Da to 10,000 Da, from 2000 Da to 10,000 Da, from 3000 Da to 10,000 Da, from 5000 Da to 10,000 Da, from 450 Da to 7000 Da, from 450 Da to 5000 Da, or from 7000 Da to 10,000 Da, as determined by gel permeation chromatography.

In some embodiments, the oligomers removed in step (ii) include an amount of oligomers having a molecular weight of from 450 to 20,000 Da of from 0.1% to 10%, from 0.1% to 8%, from 0.1% to 6%, from 0.1% to 4%, or from 0.1% to 2% as determined by gel permeation chromatography.

The polymers prepared in step (i) may be referred to as raw polymer. To obtain the desired polymer composition, the raw polymer obtained may be cleaned to remove certain low molecular weight polymers and oligomers. As used herein, the term “cleaning” refers to processes that purify a mixture of polymers to isolate polymers with a desired molecular weight distribution. Any suitable cleaning technique may be used, such as fractionation, size exclusion chromatography, and membrane filtration. In some embodiments, the cleaning process involves immersing the polymers in a solvent, such as methanol to remove oligomers from the polymer.

In some embodiments, the polymerization step (I) includes a catalyst. For example, the catalyst may be tetramethylguanidine. The catalyst may be used in an amount as low as about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1 wt. %, about 1.5 wt. %, about 2.0 wt. %, about 3.0 wt. %, about 4.0 wt. %, about 5.0 wt. % or greater than about 5.0 wt. %, or within any range encompassed by any two of the foregoing endpoints, based on the total weight of the monomers. For example, the catalyst may be used in an amount of from about 0.1 wt. % to about 5.0 wt. %, or from about 0.5 wt. %, to about 4 wt. %.

Compositions according to the present invention may be processed into useful forms, shapes and products and articles according to methods known to those skilled in the art of processing of simple and complex materials and single- and multi-component shapes and articles. The compositions may be processed into these forms on their own, or optionally blended with other components. Suitable non-reactive other matter, such as other polymeric and oligomeric species, additives, reinforcing agents, fillers, and the like may be incorporated into the polymer compositions during processing.

Typical examples of such methods are granulation, pelletizing, compounding, melt-, solution-, paste-, and solid-state-blending, injection molding, additive manufacturing, compression molding, extrusion, casting, spinning, electro-spinning, blow molding, coating, adhesion, welding, melt-rotation molding, dip-blow-molding, impregnation, extrusion blow-molding, roll coating, embossing, vacuum forming, coextrusion, foaming, rolling, and the like.

In some embodiments, the polymer compositions may be calendered to produce a composite film. The composite film may be a cohesive and flexible tape. As used herein, the term “cohesive” is meant to describe a tape that is sufficiently strong for further processing. Though depending on the blend of filler and polymer used, the calendering temperature may be from 100° C. to about 350° C., or from about 110° C. to about 330° C., or from about 120° C. to about 300° C. In some embodiments, the maximum calendering temperature may be from about 250° C. to about 300° C.

During or after processing the macromolecular structures may be subjected to elongational flow forces, tensile drawing, or blowing, which permits orientation to cause, create or enhance physical properties along the directions of flow or draw, such as, depending on the intrinsic properties of the compositions, among others, stiffness, strength, electrical conductivity, birefringence, barrier properties.

### Transfer Layer

During wear test of the siloxane polymer composition disclosed herein using various methods described herein, and as demonstrated by the Examples herein, the siloxane polymer composition produces a plurality of particles deposited on at least a portion of the countersurface during the test, the particles forming a transfer layer adhered to the countersurface.

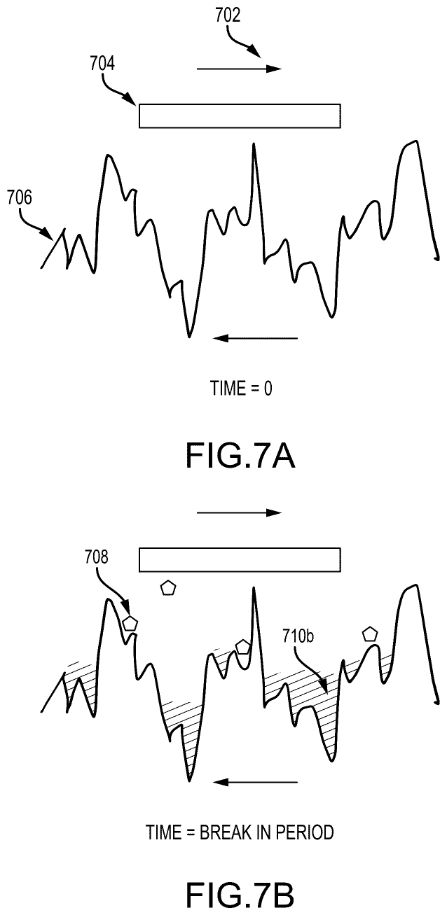

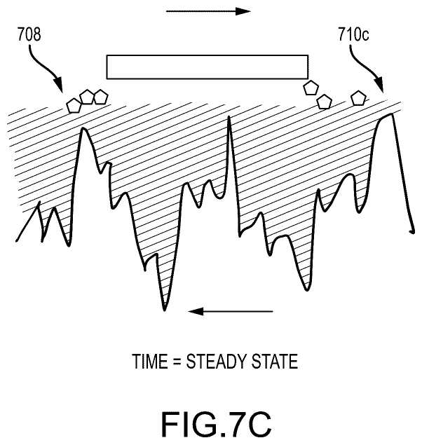

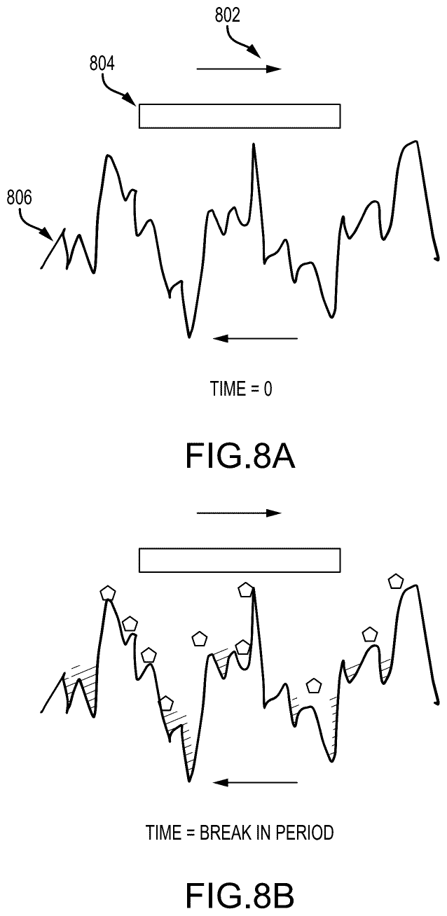

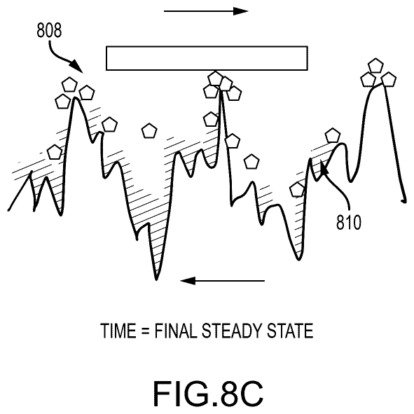

FIGS. 7A-7C are schematic diagrams of a block-on-disk test conducted using a countersurface against a poly(tetramethyl-p-silphenylenesiloxane) (PTMPS) polymer described herein. At the beginning of the test, a PTMPS polymer block 704 frictionally engages a countersurface 706 along a wear direction 702. The countersurface 706 has a textured topography characterized by a plurality of irregular protrusions (e.g., peaks) and depressions (e.g., valleys). During an intermediate break-in period, as demonstrated by Examples herein, the polymer block 704 generates siloxane (e.g., PTMPS) polymer particles that deposit onto the countersurface and adhere to the countersurface to form part of the transfer layer 710b. In some embodiments, the siloxane polymer particles of the transfer layer 710b at least partially fill in the depressions formed between adjacent protrusions, conforming to the textured topography of the countersurface 706.

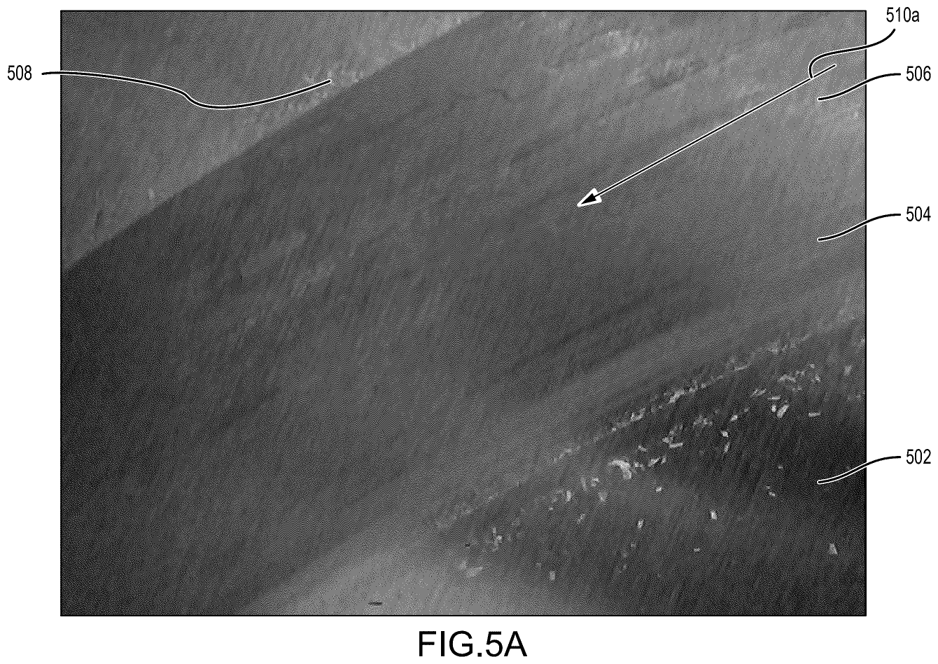

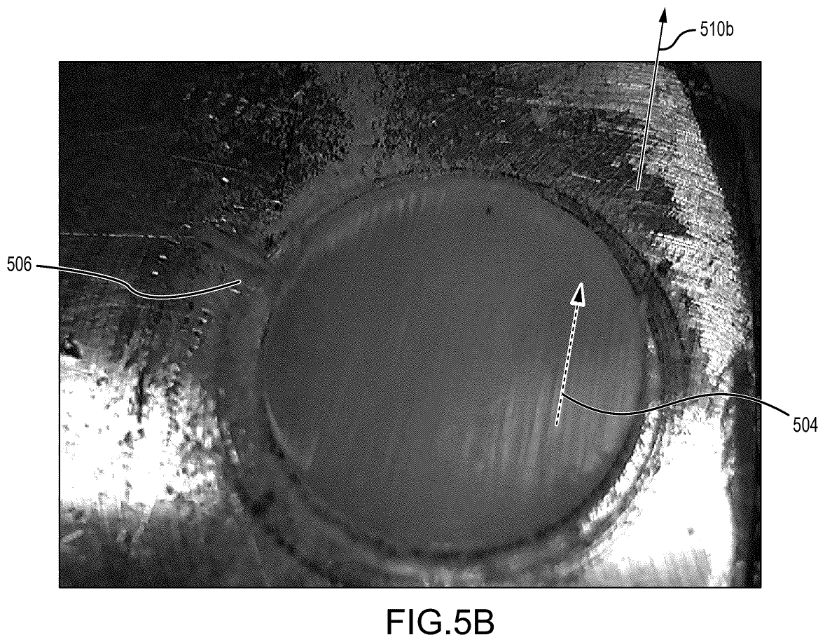

In some embodiments, some of the generated siloxane polymer particles become worn siloxane polymer particles that dislodge from the surface of the polymer block and expelled in various directions around the two engaged surfaces. In some embodiments, for example as shown in FIG. 5B and described in further details below, the worn siloxane polymer particles that are not part of the transfer layer are expelled in a direction substantially perpendicular to the wear direction 702 such that the worn particles are deposited substantially along the sides of a wear track formed on a surface of the polymer block in a direction perpendicular to the direction of wear track. In some embodiments, the worn siloxane particles deposited along the side of the wear track around the worn polymer surface do not agglomerate. Without wishing to be bound by theory, the reason that the worn siloxane particles are deposited along the side of the wear track is due to the particles abrading and being pushed to the edge of the material and deposited on the edges of the transfer layer and not enough heat is generated by friction to cause them to agglomerate.

Referring now to FIG. 7C, as the test progresses and reaches steady state, the transfer layer 710c including PTMPS particles completely fills in all the valleys or depressions of the countersurface 706. In some embodiments, the transfer layer 710c covers the peaks or protrusions of the countersurface 706 after filling in most of the valleys on the countersurface 706. In certain embodiments, the transfer layer 710c covers the entire surface of the countersurface 706. In some embodiments, the transfer layer 710d adheres to the countersurface via physical bonding between the siloxane polymer particles and the countersurface.

As can be appreciated from FIGS. 7A-7C when taken together, and from the description provided above, a process is defined where the unmodified countersurface (706 in FIG. 7A) is modified during the wear process (710b in FIG. 7B) to provide a modified countersurface (710d in FIG. 7C), with the modified countersurface having a coefficient of friction that is less than the coefficient of friction first presented by the unmodified countersurface. More specifically, FIGS. 7A-7C illustrate a method of modifying a countersurface 706 where the (1) unmodified countersurface 706 is positioned to frictionally engage a surface of a poly(tetramethyl-p-silphenylenesiloxane) (PTMPS) polymer 704, (2) then by a wear process 702, PTMPS polymer particles 708 leave the PTMPS polymer 704 and are deposited on the countersurface 706, and (3) the countersurface 706 is thereby modified by the deposition of PTMPS particles 708 to create a transfer layer 710b and 710d of the transferred PTMPS polymer particles fixedly deposited on the unmodified countersurface. As also described and illustrated, the transferred PTMPS particles have adhesive properties that fix the particles to the countersurface to form a stable transfer layer. As was also observed and described herein, the modified countersurface presents a coefficient of friction that is less than an initial coefficient of friction provided by the unmodified countersurface.

In some embodiments, the countersurface before the block-on-disk test of the PTMPS polymer has a first surface profile generating a first Abbott-Firestone curve, and a second surface profile generating a second Abbott-Firestone curve after the block-on-disk test of the PTMPS polymer. In certain embodiments, the first Abbott-Firestone curve characterizing the countersurface prior to the test is dissimilar to the second Abbott-Firestone curve characterizing the countersurface after the test of the PTMPS polymer. The dissimilarity between the two Abbott-Firestone curves shows that a transfer layer including the PTMPS polymer tested was deposited onto the countersurface during the test. In some embodiments, the first Abbott-Firestone curve includes about 1% material ratio as defined on an x-axis of the first Abbott-Firestone curve at about 5% depth as defined on a y-axis of the second Abbott-Firestone curve. In some embodiments, the second Abbott-Firestone curve includes about 15% material ratio as defined on an x-axis of the second Abbott-Firestone curve at about 5% depth as defined on a y-axis of the second Abbott-Firestone curve. In certain embodiments, the second Abbott-Firestone curve includes about 14% more material ratio at about 5% depth compared to the first Abbott-Firestone Curve.

According to some embodiments, the second Abbott-Firestone curve associated with the second surface profile having a transfer layer including PTMPS polymer deposited thereon has an Rku value of less than 3, less than 2.5, less than 2, less than 1.5, less than 1.4, less than 1.3, less than 1.2, less than 1.1, less than 1, or within any range encompassing any two of these values as endpoints. In some embodiments, the second Abbott-Firestone curve has an Rku value less than the first Abbott-Firestone curve associated with the first surface profile of a clean countersurface, showing that the countersurface coated with a transfer layer including PTMPS polymer has a more plateau-like profile with fewer extreme peaks or valleys compared to a clean countersurface prior to the wear test.

In some embodiments, a wear engagement system includes a polymeric surface comprising a siloxane polymer as described herein and a modified countersurface engaging the polymeric surface at a pressure of from 1 MPa to 10 MPa, a velocity of 200 mm/s to 2000 mm/s, and a contact radius of about 80 mm for a sliding distance of about 0.5 m/rev. In some embodiments, the modified countersurface includes an original countersurface of a disk and a transfer layer formed of particles shed from the polymeric surface comprising particles of the siloxane polymer during an initial wear period of the wear engagement system.

In some embodiments, a method of modifying a countersurface includes disposing an unmodified countersurface to frictionally engage a surface of a polymer block including the PTMPS polymer compositions described herein, transferring a plurality of PTMPS polymer particles from the surface of the polymer block to the countersurface during a frictional engagement, and modifying the countersurface to include an engaged transfer layer of the transferred PTMPS polymer particles fixedly deposited on the unmodified countersurface. In certain embodiments, the unmodified countersurface presents a first coefficient of friction and the modified countersurface presents a second coefficient of friction, the second coefficient of friction being less than the first coefficient of friction.

FIGS. 8A-8C are schematic diagrams of a block-on-disk test conducted using a hardened steel countersurface against an ultra-high molecular weight polyethylene (UHMWPE) polymer. At the beginning of the test, a UHMWPE polymer block 804 frictionally engages a countersurface 806 along a wear direction 802. The countersurface 806 has a textured topography characterized by a plurality of irregular protrusions and depressions. During an intermediate break-in period, as demonstrated by comparative or reference examples herein, the polymer block 804 generates UHMWPE polymer particles that mostly become worn UHMWPE polymer particles 808 that dislodge from the surface of the polymer block and expelled in various directions around the two engaged surfaces. Some of the remaining UHMWPE particles 810 are deposited in the valleys on the countersurface 806. However, insufficient amount of the UHMWPE particles deposited in the valleys are present on the countersurface 806 after the wear test to substantially change the surface contour of the counter surface 806.

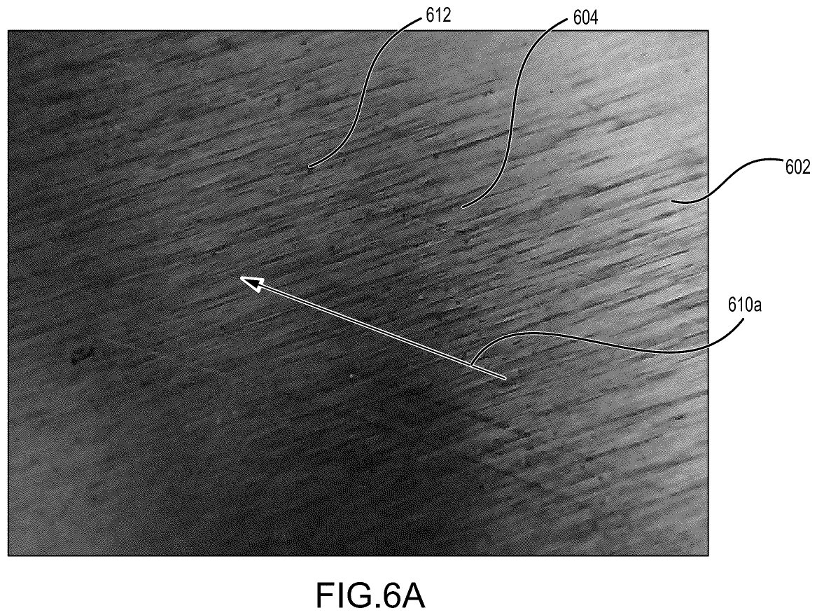

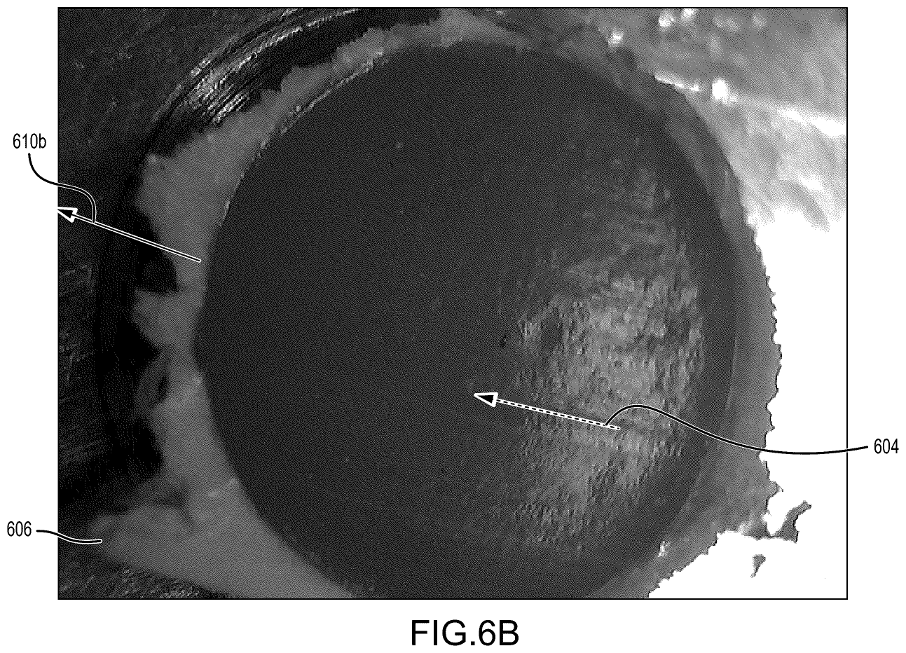

In some embodiments, for example as shown in FIG. 6B, the worn UHMWPE polymer particles are expelled in a direction substantially along the wear direction 802 such that the worn particles are deposited substantially on one or both ends of a wear track formed on a surface of the polymer block in a direction along the direction of the wear track. In some embodiments, the worn UHMWPE particles deposited on one or both ends of the wear track around the worn polymer surface fuses together to form larger particle agglomerates or clusters. Without wishing to be bound by theory, the absence of an observable transfer layer on the counter surface engages the UHMWPE polymer is due to the fact that UHMWPE particles tend to form agglomerates with each other around the polymer surface instead of adhering to the countersurface during the test.

The countersurface before the block-on-disk test of the UHMWPE polymer has a first surface profile generating a first Abbott-Firestone curve, and a third surface profile generating a third Abbott-Firestone curve after the block-on-disk test of the UHMWPE polymer. The first Abbott-Firestone curve characterizing the countersurface prior to the test is similar to the third Abbott-Firestone curve characterizing the countersurface after the test of a UHMWPE polymer, showing that very little UHMWPE polymer is deposited on the countersurface during the wear test, if any. The third Abbott-Firestone curve may have an Rku value of greater than 3, greater than 3.5, or greater than 3.6, showing that the countersurface tested against a UHMWPE polymer tends to have “heavy tails” or sharp peaks and valleys dominating the profile, indicating potential for high local contact stresses.

The following examples are given as illustrative embodiments of the invention and to demonstrate the practice and advantages thereof. It is understood that the examples are given by way of example only and are not intended to limit the claims that follow in any manner.

### Test Methods

It should be understood that although certain methods and equipment are described below, other methods or equipment determined suitable by one of ordinary skill in the art may be alternatively utilized.

### Wear (Pin-On-Disk Using Ceramic Ball)

Wear was measured employing equipment and according to the following procedure and is expressed as the wear rate κ in mm³/mN.

Samples for wear tests were compression molded from the molten state at 180° C. in a Carver press (model M, 25T) for 10 min at 1 metric ton and 10 min at 10 metric ton and then cooled to room temperature on a room temperature copper block. The test coupons typically were of a thickness of 0.3 mm and a diameter of 25 mm.

Wear was measured employing the type of equipment and according to the general procedures described in detail in T. A. Tervoort et al., Macromolecules, 2002, 35, p. 8467-8471, and is expressed as the wear rate κ in mm³/mN. In the set-up employed, the ceramic ball is type RB30MM/G20 diameter 28 mm, dimensional tolerance 2 μm (AKN WÄLZLAGER GmbH), rotating at 300 rpm, and the abrasive slurry is DiaPro Dac 3 μm (40600371, Struers GmbH). Normal force is 0.28 N.

For wear tests of the following examples, an RTEC MFT-5000 Tribometer was used with Pin on Disk geometry with 6.35 mm Si₃N₄ Balls.

The temperature was ambient (e.g., from about 20° C. to about 22° C.). The load was either 5 N or 10 N and the speed was set to 10 RPM. The travel distance was 9 meters and the track diameter was 12 & 10 mm.

### Wear (Pin-On-Disk Using Stainless Steel Ball)

Wear was measured employing equipment and according to the following procedure and is expressed as the wear rate κ in mm³/mN.

Samples for wear tests were compression molded from the molten state at 180° C. in a Carver press (model M, 25T) for 10 min at 1 metric ton and 10 min at 10 metric ton and then cooled to room temperature on a room temperature copper block. The test coupons typically were of a thickness of 0.3 mm and a diameter of 25 mm.

For wear tests of the following examples, an RTEC MFT-5000 Tribometer was used with Pin on Disk geometry with 6 mm stainless steel balls.

The temperature was ambient (e.g., from about 20° C. to about 22° C.). The load was 10 N (25149 Psi) and the speed was set to 2 RPM (0.411 ft/min). The test duration was 60 hours. The travel distance was 1480 feet and the track diameter was 20 mm.

### Wear (Block-On-Disk)

Wear was measured employing equipment and according to the following procedure and is expressed as the wear rate in nm/m. The block-on-disk wear test was operated to generate wide spectrum friction and wear data. The test generally follows applicable ASTM Wear of Materials Standards methodology in all procedural respects. The protocol includes an implicit break-in period to achieve normalization of the test sample, the mating surface and environmental conditions, followed by a wear test of sufficient duration to achieve a reliable, measurable wear rate. Specific test configurations are summarized below in Table 1.

TABLE 1
Block-on-Disk Wear Test

| | |
|---|---|
| Counter Face Material | Hardened Steel disk, through hardened |
| | for a surface hardness HRc 50-52. |
| | Surface ground to Ra 0.25 to 0.30 |
| | micron (10 to 12 micro-inch) |
| Contact Radius | Sample contacted the countersurface of |
| | the disk at a radius of 80 mm for a |
| | sliding distance of 0.5 m/rev. |

| | | |
|---|---|---|
| Minimum Pressure | 1 | MPa |
| Maximum Pressure | 10 | MPa |

| | |
|---|---|
| Pressure Increments | 10, evenly spaced every 1 MPa |

| | | |
|---|---|---|
| Minimum Velocity | 200 | mm/s |
| Maximum Velocity | 2000 | mm/s |

| | |
|---|---|
| Velocity Increments | 10, evenly spaced every 200 mm/s |
| Break-in | 20 minutes @ 3 Mpa & 2000 m/s |

The contact pressures are pneumatically controlled with PID loop feedback to achieve high programmable accuracy and stability. Test sequenced 100 permutations for 10 increasing sliding speeds at 10 increasing pressures. All speeds are tested at each pressure before incrementing to the next highest pressure.

This system does not require breaking before testing. Break-in is detected through thermal stability and wear rate linearity (steady state conditions). A break in period is used to establish a transfer film layer and burnish the material surface. This reduces the time required for detection of steady state conditions.

For each P-V permutation, at each revolution of the countersurface disk, differential laser measurements were made of the countersurface and the back of the sample holder. This was recorded at a resolution of 10 nm (0.4 micro-inch). Simultaneously, the average contact pressure, average friction, and average sample holder temperature for each revolution were recorded. Summary data recorded the wear rate and the averages of wear rate correlation coefficient, coefficient of friction, and temperature were recorded for the period corresponding to the recorded wear rate.

### Surface Profile

A stylus based profilometer was used to generate the surface profile curves before and after each test as described herein. As a stylus is pulled across the surface over a defined distance, a transducer collects and digitizes the signal. The y-axis (um) shows the height/depth of the peaks and valleys on the measured surface. The x-axis (mm) shows the relative position of the stylus along a line of the measured surface.

### Friction

Friction was measured according to standard procedures with a Bruker UMT TriboLab Mechanical Tester and Tribometer. The method includes a pin-on-disk test against Si₃N₄ (SN 101C, Grade 5, Saint-Gobain Advanced Ceramics) at room temperature for a period of 1 hr at a sliding speed of 1 mm/s, a sliding distance of 14 mm, a rotation of 1 rpm and a static pressure of 15 N. The coefficient of friction (COF) is expressed as u.

### Molecular Weight

Gel Permeation Chromatography or Size Exclusion Chromatography for molecular weight determination was conducted using a Malvern OMNISEC® Reveal (Malvern PANanalytical, Westborough, MA) with Shodex columns KF-806L, KF-803 and KF-802.5, tetrahydrofuran (Sigma-Aldrich, GPC grade) solvent at 0.8 mL/min flow rate, and an injection volume of 100 μL at a PTMPS concentration of 10 mg/mL at 30° C.

### Hardness

Hardness was tested according to Shore A and Shore D (DIN 53505, ISO 7819-1, DIN EN ISO 868)

“Hardness according to Shore” is understood to mean the resistance to penetration of an object of a specific shape and defined spring force. The Shore hardness is the difference between the numerical value 100 and the penetration depth of the penetration object in mm under the influence of the test force divided by the scale value 0.025 mm. During testing according to Shore A, a truncated cone with an opening angle of 35° is used as the penetration object, and in Shore D, a cone with an opening angle of 30° and a tip radius of 0.1 mm is used. The penetration objects consist of polished, tempered steel.

### Sample Preparation

Poly(tetramethyl-p-silphenylenesiloxane) (PTMPS) samples are produced and analyzed according to WO2021202628. Three grades of different weight-average molecular weights (MW) are employed, i.e., 318,000, 477,000 and 690,000 Da. PTMPS with Mw of 318,000 Da was used straight from the reactor without cleaning and is considered raw. PTMPS with Mw of 477,000 Da and 690,000 Da respectively were finished polymers. Molecular weight fraction below 20,000 Da is listed in Table 2.

Ultra-high molecular weight polyethylene (UHMWPE) grade 210 (DSM) of MW 2,063,000 Da, polydispersity of 7.2 is used as a reference and was prepared according to the procedure outlined in T. A. Tervoort et al., Macromolecules, 2002, 35, p. 8467-8471.

Films of approximately 0.5 mm thick and plaques of approximately 3 mm tick, all of a diameter of about 40 mm of the polymers were produced by compression molding at 180° C. for 10 min at 1 ton and 10 min at 10 ton under common conditions, followed by cooling to room temperature yielding semi-translucent films and plaques. No further treatment was applied.

### EXAMPLES

Reference Example 1: The wear rate of a melt-compression molded film of UHMWPE 210 of a thickness of 0.6 mm was tested according to the Test Methods described herein. The wear rate κ observed for the tested material was determined to be 2.72×10⁻⁶ mm³/mN.

Reference Example 2: Friction of a melt-compression molded plaque of UHMWPE 210 of a thickness of 3.2 mm was tested according to the Test Methods described herein. The average coefficient of friction μ observed for the tested material was determined to be 0.05.

The product of the wear rate of 2.72×10⁻⁶ mm³/mN, Reference Example 1, and the average friction coefficient μ of 0.05, Reference Example 2, result in a wear coefficient α of 13.6×10⁻⁶ mm³/mN (friction coefficient μ×wear rate, κ, mm³/mN).

Reference Example 3: The wear rate of a melt-compression molded film of HDPE HD 8621 (DSM) of a thickness of 0.6 mm was tested according to the Test Methods. The wear rate κ observed for the tested material was determined to be 9.88×10⁻⁴ mm³/mN.

Example 1: The wear rate of a melt-compression molded film of PTMPS having a weight-average molecular weight (MW) of 318,000 Da of a thickness of 0.5 mm was tested according to the Test Methods described herein. The wear rate κ observed for the tested material was determined to be 5.8013×10⁻⁵ mm³/mN.

Example 2: The coefficient of friction of a melt-compression molded plaque of PTMPS having a weight-average molecular weight (MW) of 318,000 Da of a thickness of 3.0 mm was tested according to the Test Methods described herein. The average coefficient of friction μ observed for the tested material was determined to be 0.020.

The product of the wear rate κ of 5.80×10⁻⁵ mm³/mN from Example 1, and the average friction coefficient μ of 0.020, results in a wear coefficient α of 11.6×10⁻⁷ mm³/mN.

Example 3: The wear rate of a melt-compression molded film of PTMPS having a weight-average molecular weight (MW) of 477,000 Da of a thickness of 0.62 mm was tested according to the Test Methods. The wear rate κ observed for the tested material was determined to be 1.36×10⁻⁶ mm³/mN. Reducing the amount of oligomers and low molecular weight species via cleaning the PTMPS having a weight-average molecular weight (MW) of 477,000 Da compared to the raw PTMPS having weight-average molecular weight (MW) of f 318,000 Da described in Example 1 (Table 2) resulted in superior wear performance.

Example 4: The coefficient of friction of a melt-compression molded plaque of PTMPS having a weight-average molecular weight (MW) of 477,000 Da of a thickness of 2.9 mm was tested according to the Test Methods described herein. The average coefficient of friction μ observed for the tested material was determined to be 0.015.

The product of the wear rate κ=1.36×10⁻⁶ mm³/mN, Example 3, and the average friction coefficient μ of 0.015, Example 4, results in a wear coefficient α of 20.4×10⁻⁸ mm³/mN.

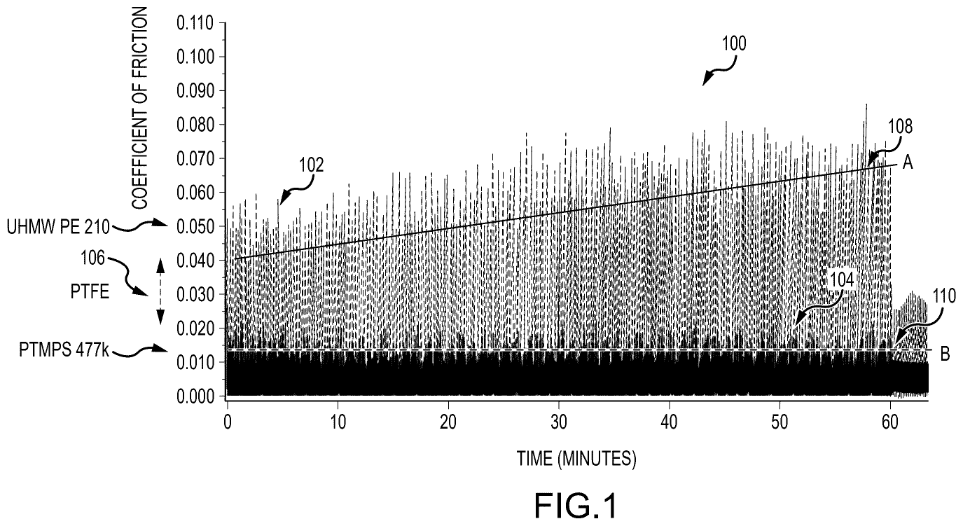

Comparative Example 1: Illustrated in FIG. 1 is a comparison (100) of the coefficients of friction (COF, y-axis) as function of testing time (x-axis) for three materials: UHMWPE 210 (identified as 102) from Reference Example 1, PTMPS (identified as 104) from Example 4, and a literature value for PTFE (identified as 106). For UHMWPE 210 (102) and PTMPS (104), the coefficients of frictions are measured and calculated according to the above referred Test Methods. The UHMWPE 210 material (102) is ultra-high molecular weight polyethylene having a weight-average molecular weight (MW) of 2,063,000 Daltons. The PTMPS material (104) is poly(tetramethyl-p-silphenylenesiloxane) PTMPS 477k having a weight-average molecular weight (MW) of 477,000 Daltons. Displayed on FIG. 1 is a Trendline A (108) representing an estimated average coefficient of friction for UHMWPE 210 over time based on individual data points at adjacent points in time and, as can be appreciated, the Trendline A shows an increase in the coefficient of friction over the course of 60 minutes. As can be further appreciated from FIG. 1, Trendline A shows a linear increase from an estimated average of 0.040 at the starting time (0 mins) to an estimated average of about 0.065-0.070 at a time that is 60 minutes later, constituting a coefficient of friction degradation that increases at a rate of +0.025 to +0.030 per hour. Trendline B (110) represents the estimated average coefficient of friction for PTMPS (104) that in comparison to Trendline A appears significantly lower than UHMWPE 210 (102). Trendline B remains essentially constant at a value of about 0.013 over 60 minutes. Improved performance of PTMPS (104) is further illustrated when compared to a range (106) of literature values from about 0.020 to 0.040 for common poly(tetrafluoroethylene) (PTFE).

As noted in literature regarding PTFE, the lowest value of 0.020 refers to the coefficient of friction of PTFE on snow, which is well-known to melt and form a film of water under those circumstances.

Example 5: The coefficient of friction of a melt-compression molded plaque of PTMPS having a weight-average molecular weight (MW) of 690,000 Da of a thickness of 3.1 mm was tested according to the Test Methods. The average coefficient of friction μ observed for the tested material was determined to be 0.024.

Example 6: To ascertain the impact of molecular weight and its distribution on coefficient of friction and wear factor, several samples were prepared from blends of finished high molecular weight and low molecular weight poly(tetramethyl-p-silphenylenesiloxane) polymers.

The polymer blends in Table 5 were prepared using 2.5 g of total polymer. The blends were made by cryogrinding the polymers and shaking them in a closed cup. The ground polymers were formed into pucks pressing them at 190° C. with vacuum for 1 hour in a 35 mm diameter die. The sample was then compressed at room temperature with 1 ton of force.

Surface roughness of pucks was obtained by scanning the surface at 50× magnification using a KeyenceVK-X100 series profilometer (Keyence Corporation). Images were processed to calculate roughness using Keyence VK series multiFileAnalyzer software (2014, Keyence Corporation).

The wear profile of the pucks was measured using a RTEC MFT-5000 Tribometer using Pin on Disk geometry with 6.35 mm Si₃N₄ Balls. The temperature was ambient, and the load was set to either 5 N (with 12 mm track diameter) or 10 N (with 10 mm track diameter). The speed was 10 RPM, and the travel distance was 9 meters.

TABLE 2
Weight fraction of molecular weight distribution
less than/equal to 20,000 Da

| | | Weight |
|---|---|---|
| Example | Polymer Type | Fraction |
| 1 | PTMPS 318,000 Da raw | 11.1% |
| 3 | PTMPS 477,000 Da finished | 8.4% |
| | PTMPS 249,000 Da raw | 13.3% |
| | PTMPS 249,000 Da finished | 8.2% |

TABLE 3
Wear rate of PTMPS compared to HDPE and UHMWPE

| | | Mw | K |
|---|---|---|---|
| Example | Polymer Type | (Da) | (mm³/mN) |
| 1 | PTMPS | 318,000 | 5.80e−05 |
| 3 | PTMPS | 477,000 | 1.36e−06 |
| | HDPE HD8621 (DSM) | 230,000 | 9.88e−04 |
| Reference 1 | UHMWPE Stamylan ® UH210 | 2063,000 | 2.72e−06 |

TABLE 4
COF and wear volume of raw versus clean PTMPS

| | | | | | | | Average |
|---|---|---|---|---|---|---|---|
| | | | | | | COF*Mean | Surface |
| PTMPS | | Normal | | COF | Mean Wear | Wear | Roughness |
| Mw Da | Processing | Force N | COF | stdev | Volume um³ | Volume um³ | um |
| 249,000 | Raw | 5 | 0.0341 | 0.0055 | 10.9e+7 | 3.72e+6 | 0.135 |
| 249,000 | Finished | 5 | 0.0519 | 0.0051 | 4.16e+7 | 2.16e+6 | 0.189 |
| 249,000 | Raw | 10 | 0.0419 | 0.0049 | 10.96e+7 | 4.59e+6 | 0.135 |
| 249,000 | Finished | 10 | 0.0527 | 0.0051 | 7.02e+7 | 3.7e+6 | 0.189 |

TABLE 5
COF and wear volume of high and low Mw Finished PTMPS

| | | | | | | | | Average |
|---|---|---|---|---|---|---|---|---|
| PTMPS | | Wt. % | | | | | COF*Mean | Surface |
| High/Low | | High | Normal | | COF | Mean Wear | Wear | Roughness |
| Mw kDa | FIG. | MW | Force N | COF | stdev | Volume um³ | Volume um³ | um |
| 287/26 | 2A, 2B, | 100 | 5 | 0.0541 | 0.0093 | 4.2e+7 | 2.28e+6 | 0.200 |
| | 2C | | | | | | | |
| 287/26 | 2D, 2E, | 90 | 5 | 0.0394 | 0.0046 | 12.34e+7 | 4.86e+6 | 0.135 |
| | 2F | | | | | | | |
| 287/26 | 2G, 2H, | 50 | 5 | 0.0305 | 0.0074 | 28.1e+7 | 8.56e+6 | 0.192 |
| | 2I | | | | | | | |
| 287/26 | | 20 | 5 | Sample | Sample | Sample | Sample | Sample |
| | | | | not | not | not | not | not |
| | | | | coherent | coherent | coherent | coherent | coherent |
| 2500/26 | | 100 | 5 | 0.0373 | 0.0079 | 6.3e+7 | 2.34e+6 | 0.0335 |
| 287/26 | 3A, 3B, | 100 | 10 | 0.0436 | 0.0068 | 3.94e+7 | 1.72e+6 | 0.200 |
| | 3C | | | | | | | |
| 287/26 | 3D, 3E, | 90 | 10 | 0.0349 | 0.0046 | 16.8e+7 | 5.86e+6 | 0.135 |
| | 3F | | | | | | | |
| 287/26 | 3G, 3H, | 50 | 10 | 0.0255 | 0.0083 | 28.4e+7 | 7.25e+6 | 0.192 |
| | 3I | | | | | | | |
| 287/26 | | 20 | 10 | Sample | Sample | Sample | Sample | Sample |
| | | | | not | not | not | not | not |
| | | | | coherent | coherent | coherent | coherent | coherent |
| 2500/26 | | 100 | 10 | 0.0344 | 0.0047 | 8.45e+7 | 2.91e+6 | 0.0335 |

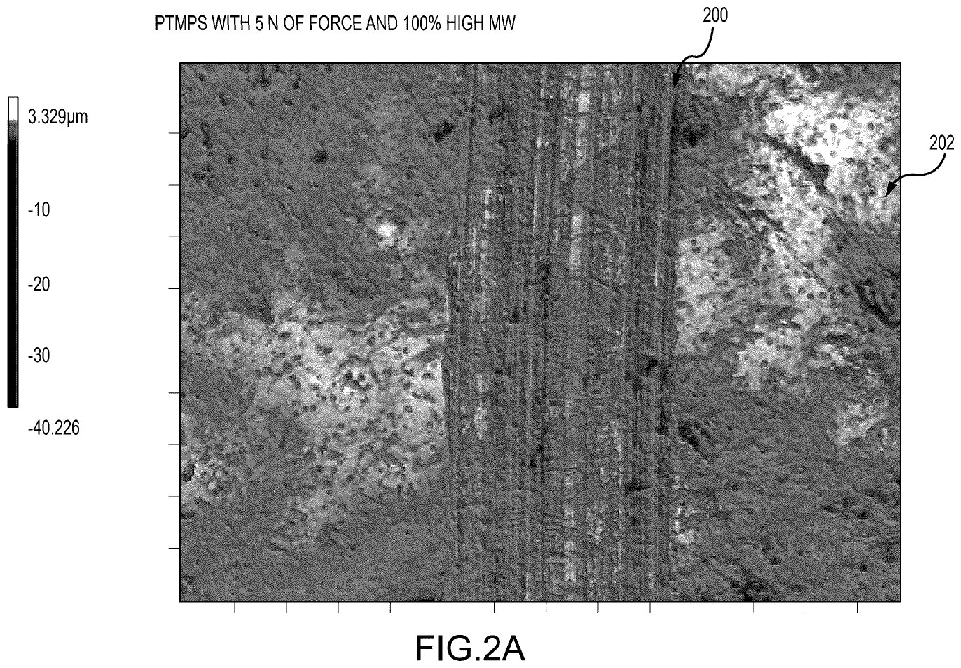

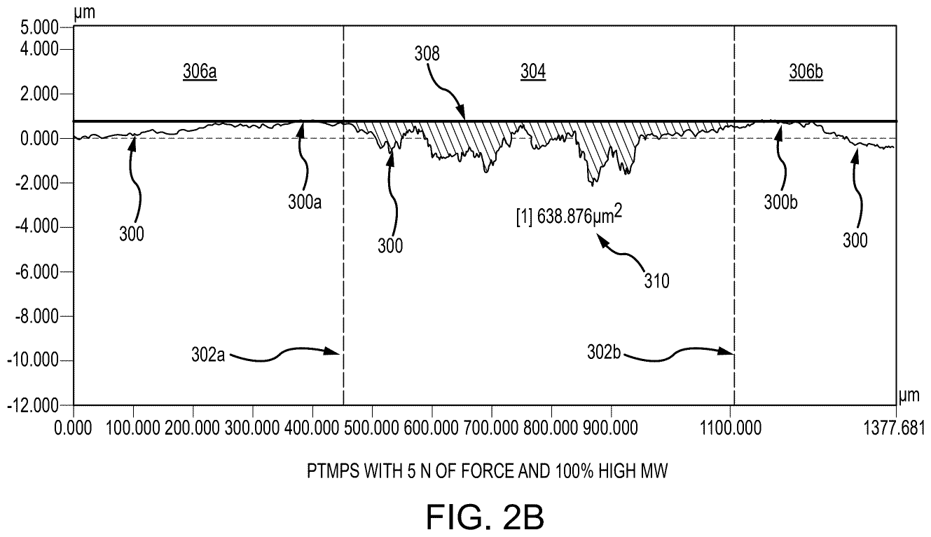

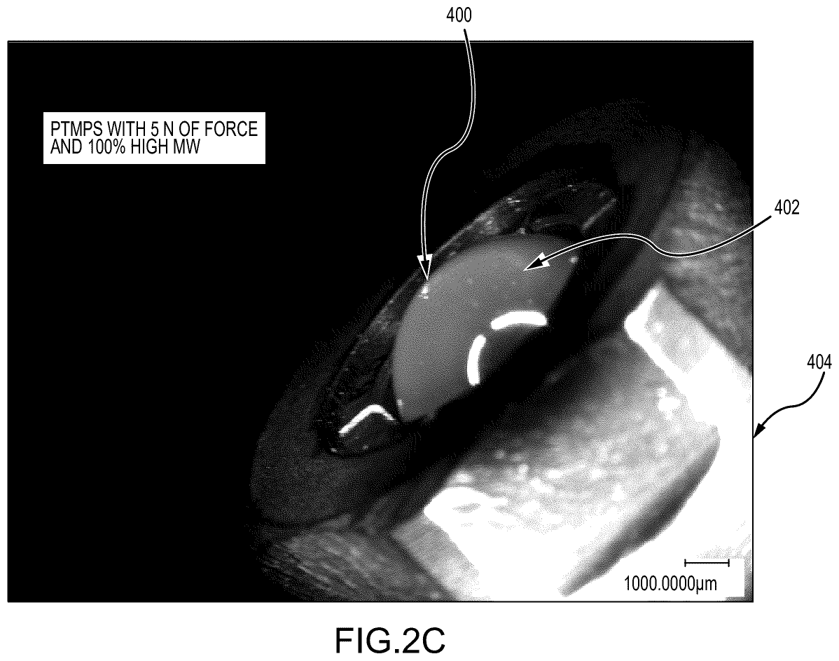

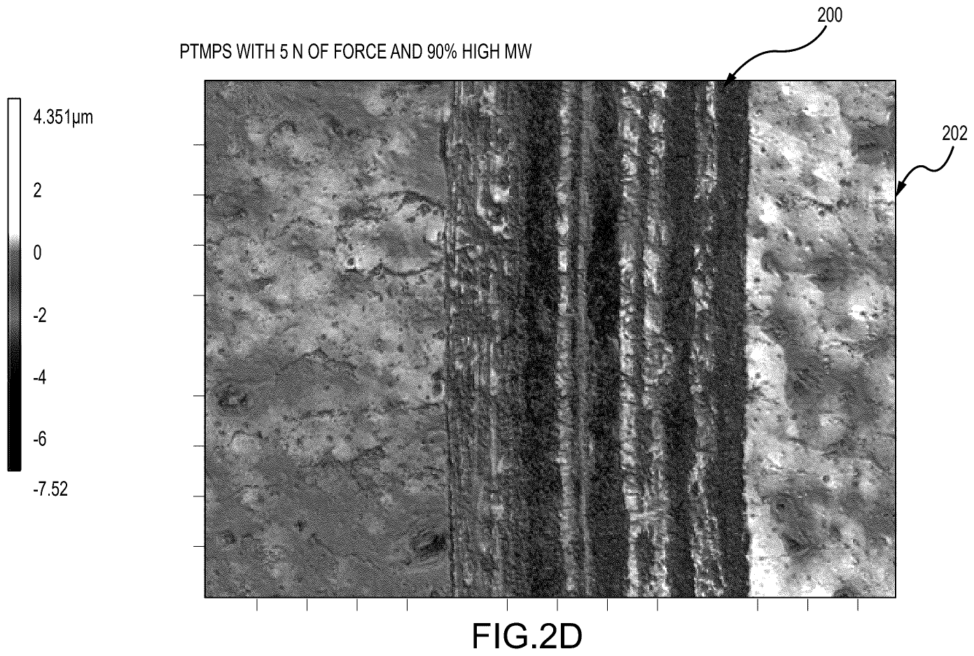

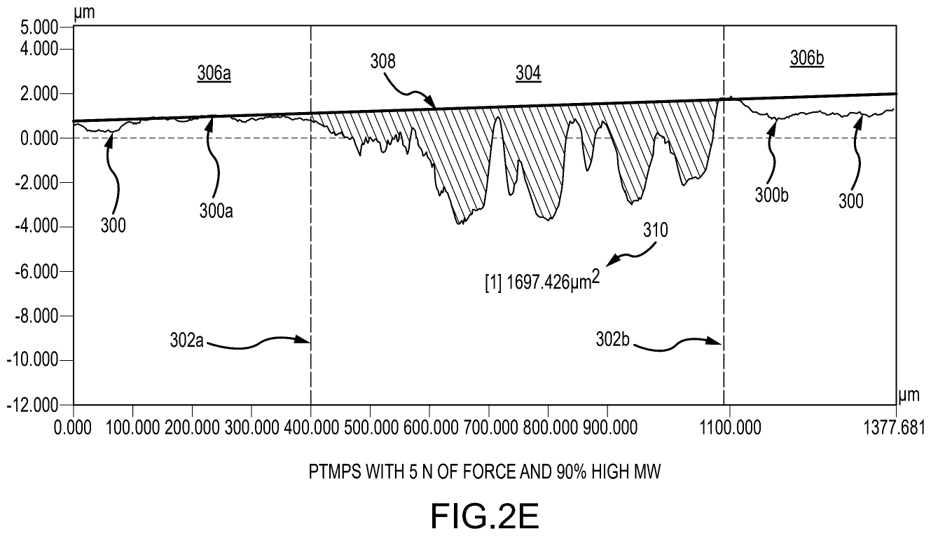

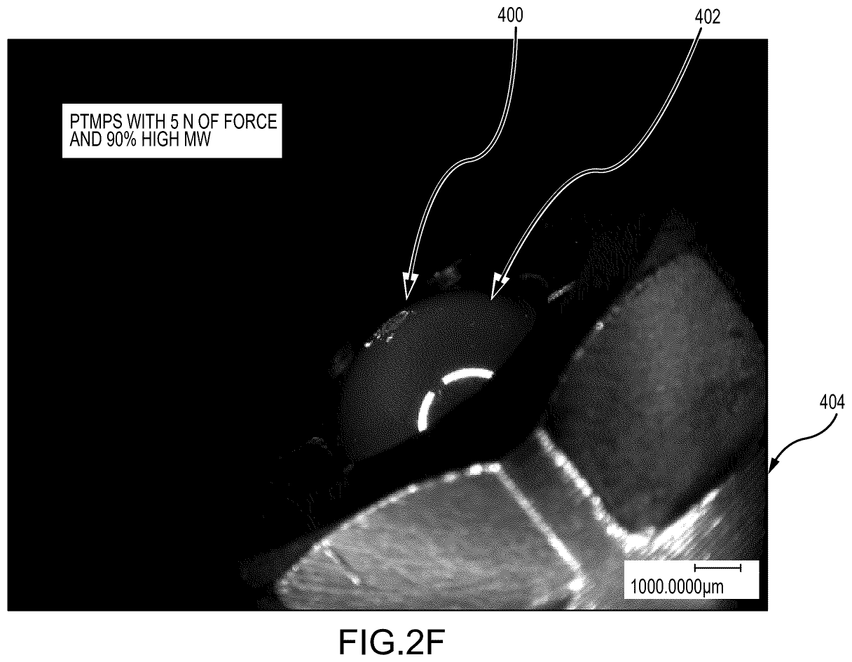

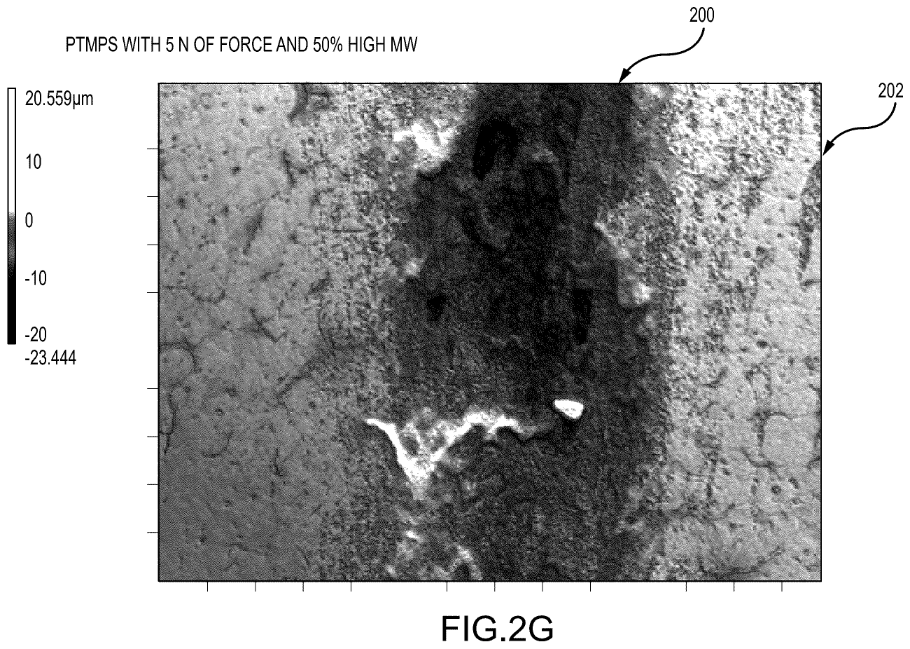

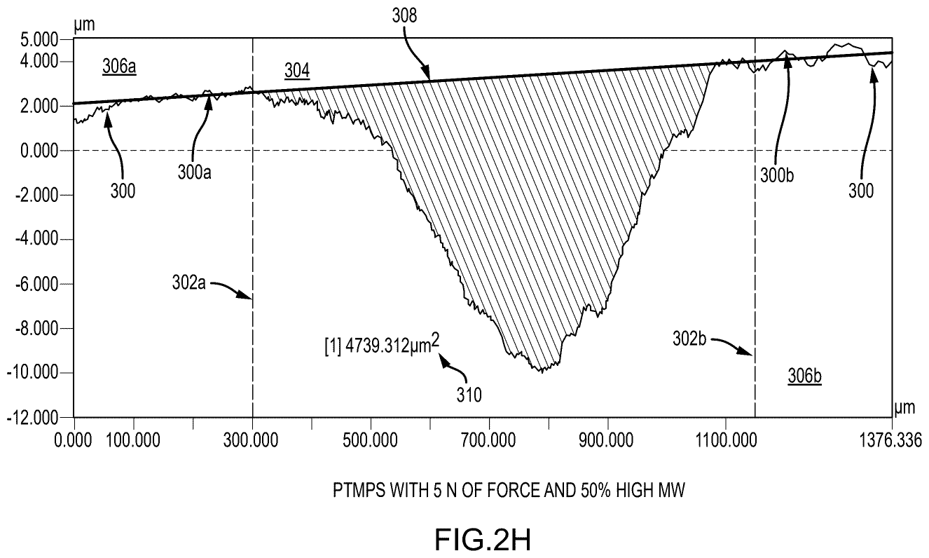

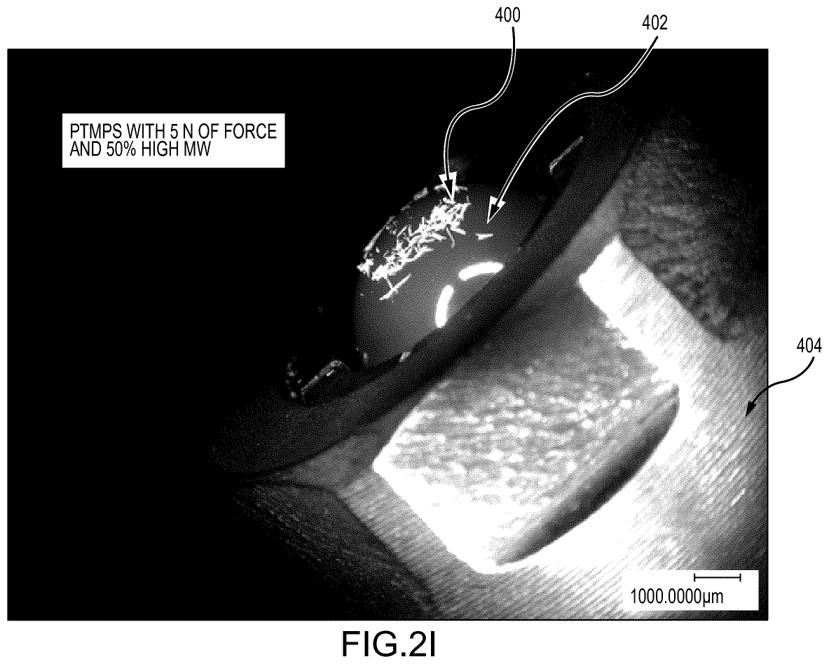

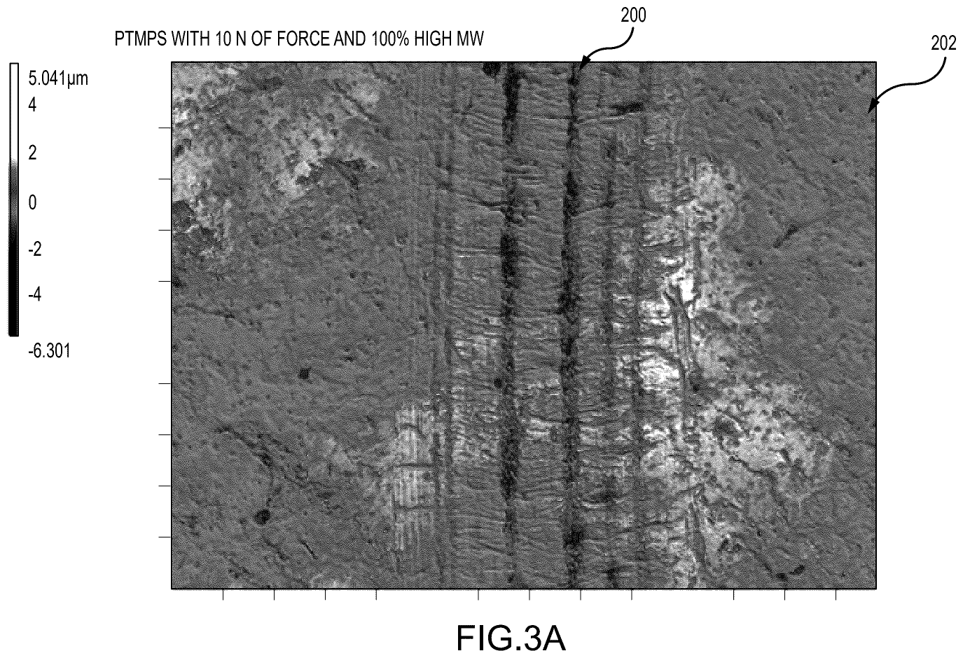

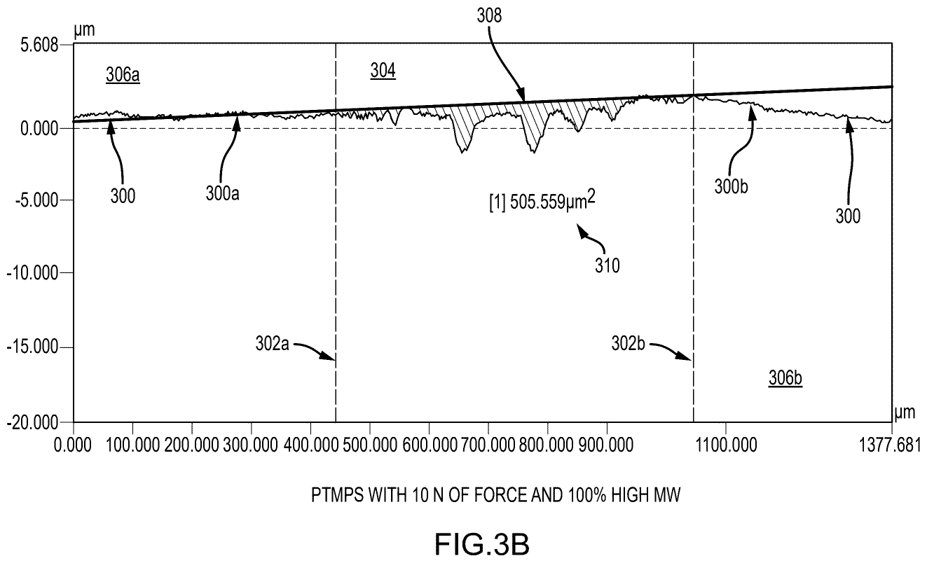

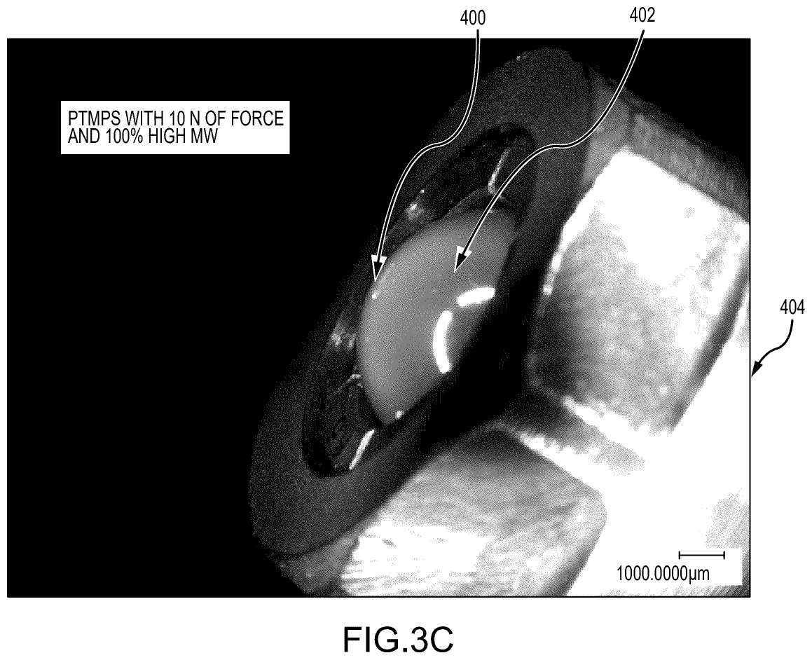

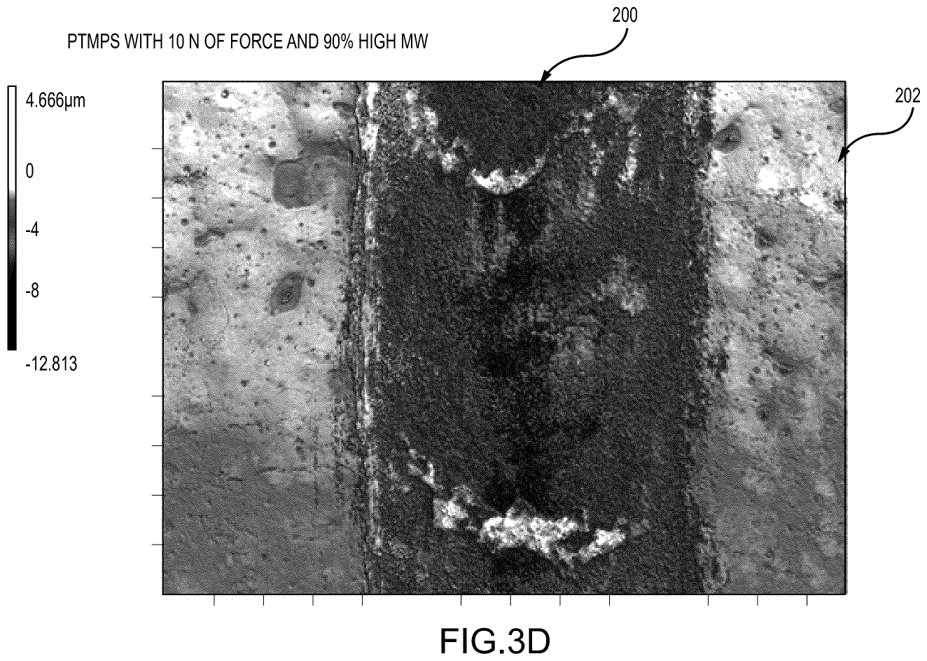

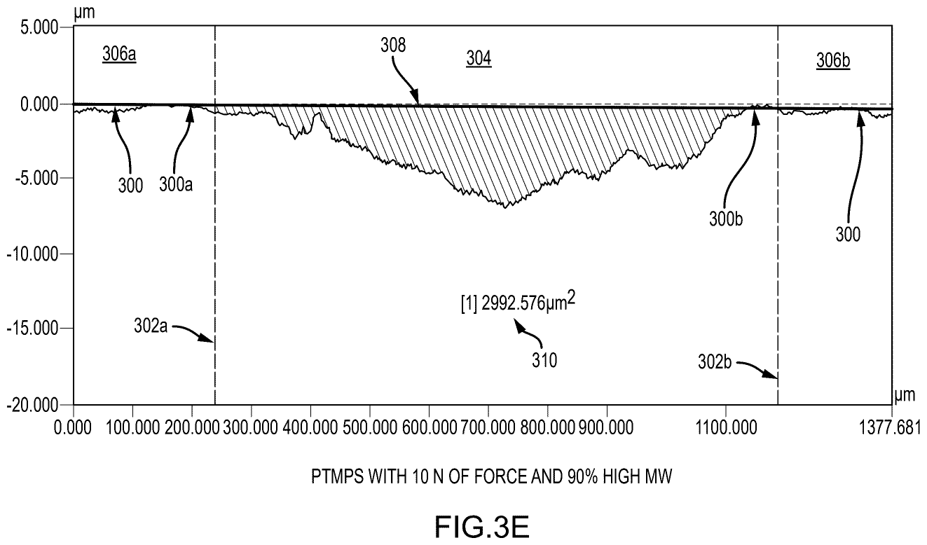

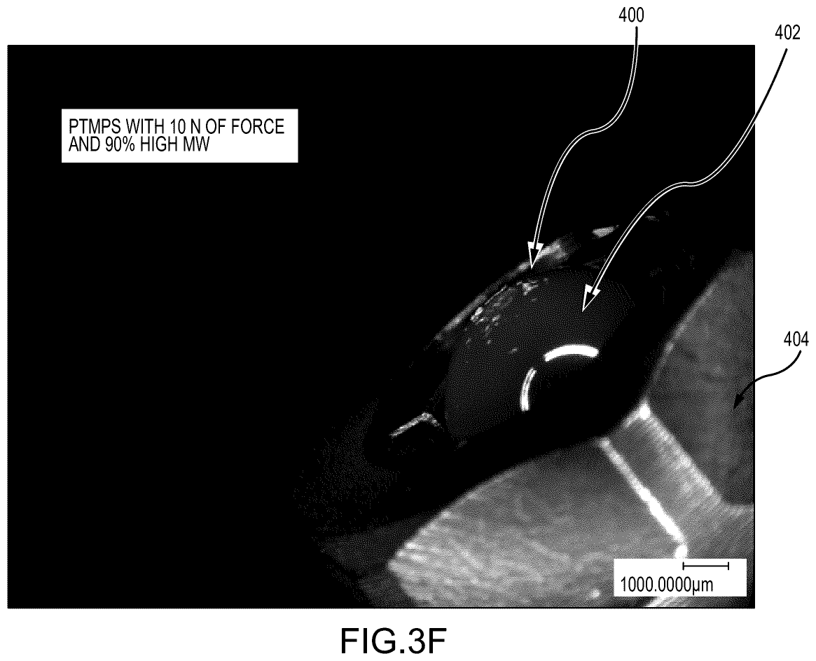

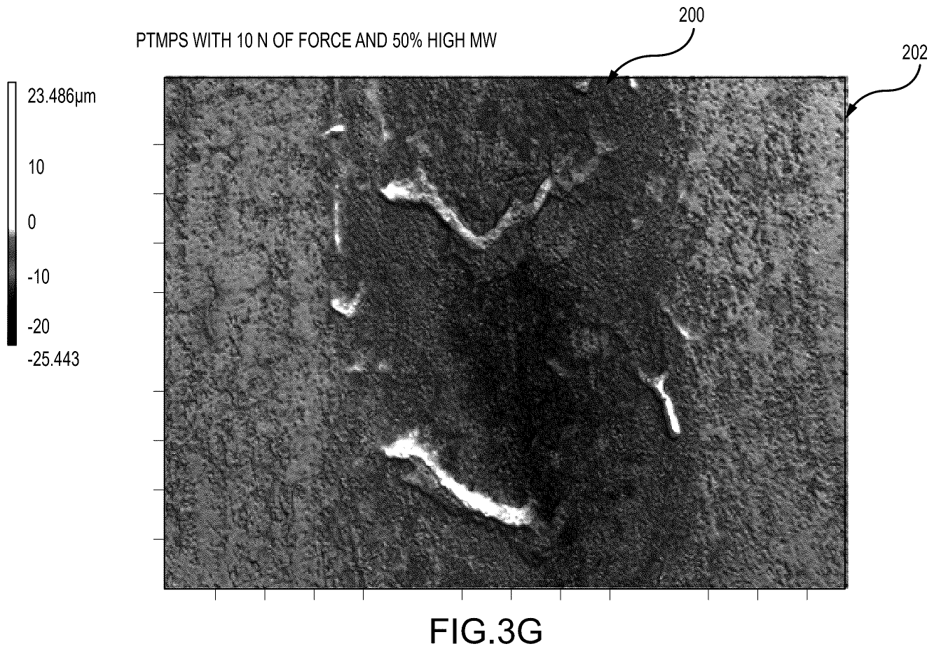

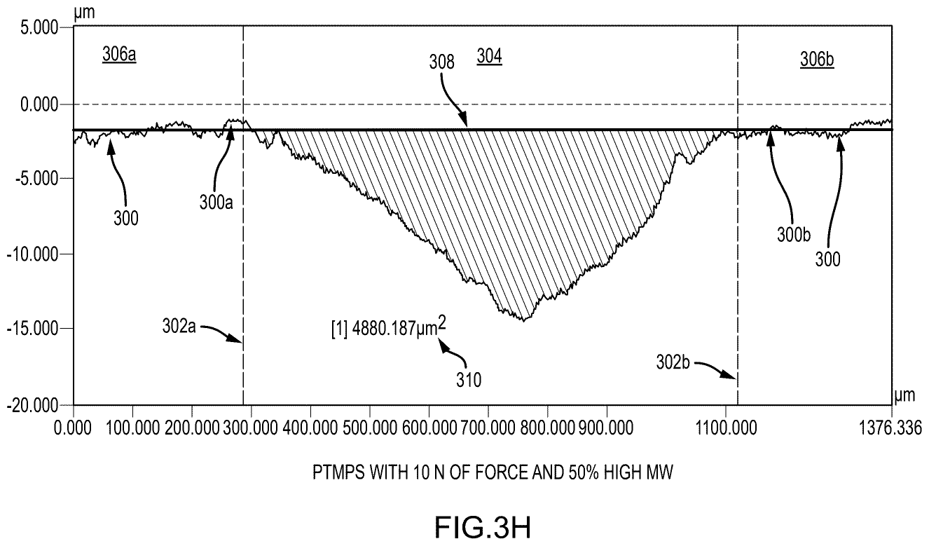

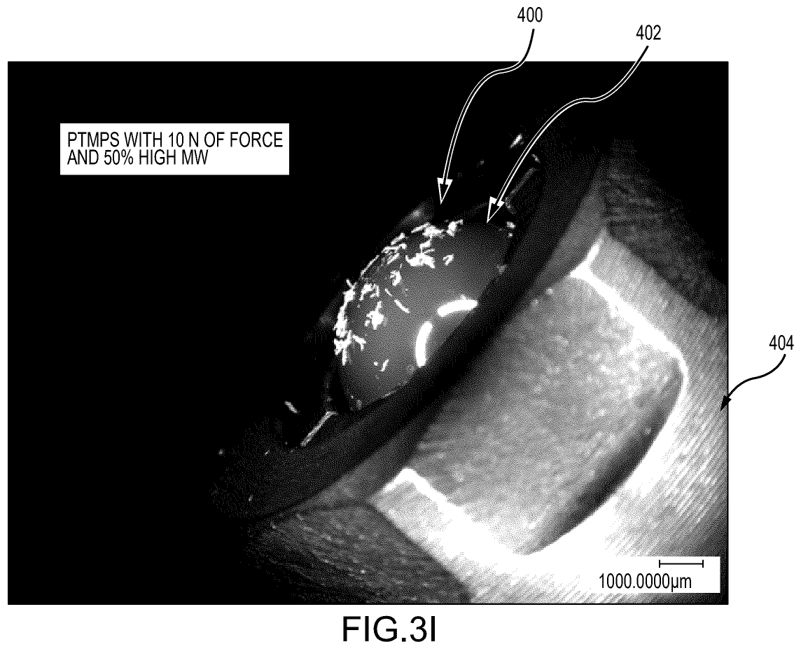

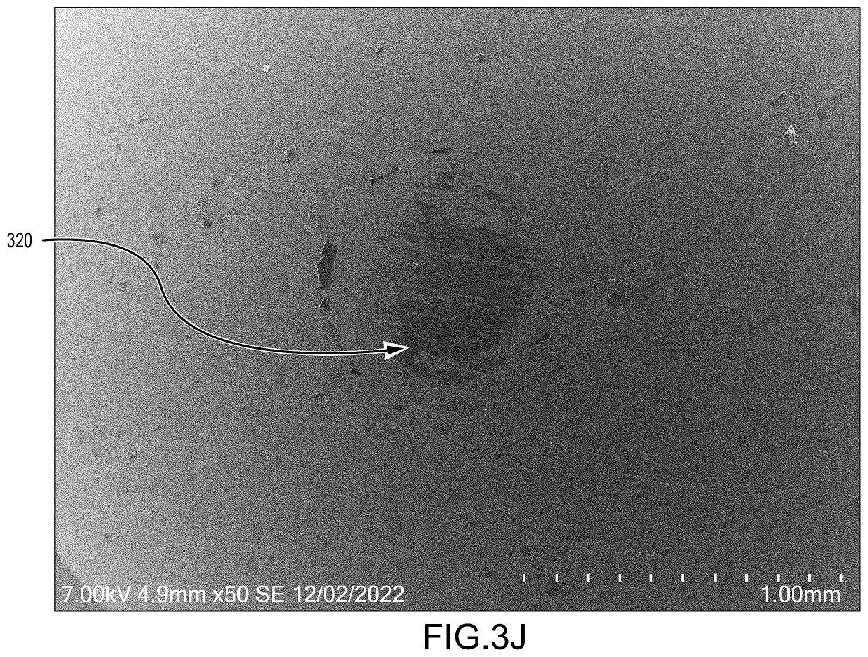

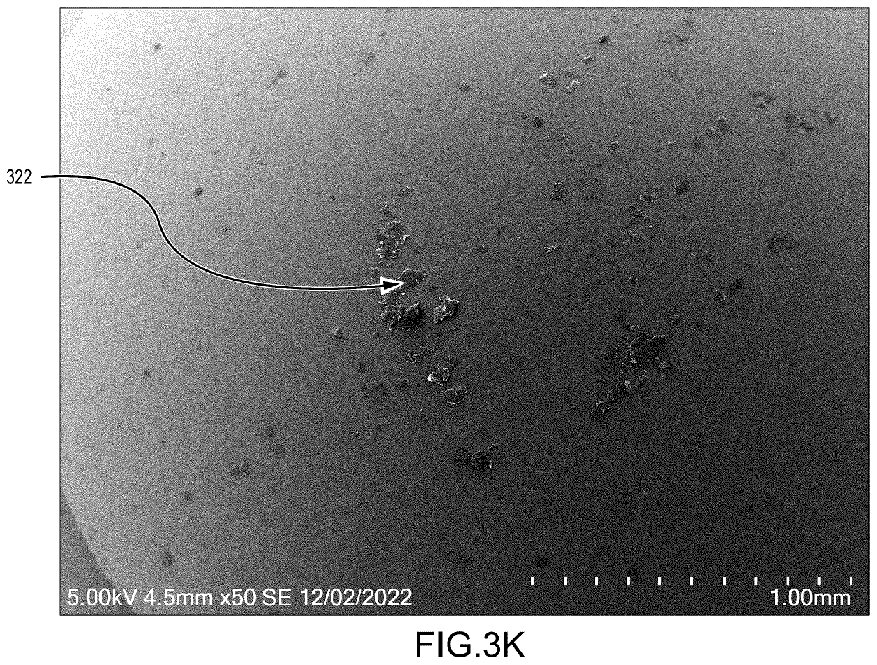

FIGS. 2A, 2D, and 2G show a false color representation of surface wear observed on poly(tetramethyl-p-silphenylenesiloxane) polymers with the application of 5 N of force. FIGS. 3A, 3D, and 3G show a false color representation of surface wear observed on poly(tetramethyl-p-silphenylenesiloxane) polymers with the application of 10 N of force. Each of these images are to the scale shown in each of the Figures. Each of these figures show an abraded region (200) where the Si₃N₄ countersurface abraded the polymer surface according to the test method described above, and a pristine region (202) which is pristine with no abrasion and representing the initial state of the surface. For simplicity, a single identifier (e.g., 200, 202) is repeatedly used in similar figures concerning different test samples, and it should be understood that such repeated use of the same identifiers are directed towards similar features presented in different samples. As can be appreciated, these above-described aspects of FIGS. 2A, 2D, 2G, 3A, 3D, and 3G show that an increasing concentration of low molecular weight PTMPS in the high molecular weight PTMPS matrix leads to higher wear (appearing as a deeper valley in the figures) that is further represented by the displayed color scale in each figure. It is submitted from these results that the increasing presence of low molecular weight, oligomers and monomers in the tested article will result in inferior wear performance.

FIGS. 2B, 2E, and 2H show the wear profile of the poly(tetramethyl-p-silphenylenesiloxane) polymers with the application of 5 N of force. FIGS. 3B, 3E, and 3H show the wear profile of the poly(tetramethyl-p-silphenylenesiloxane) polymers with the application of 10 N of force. Each of these figures are cross-sectional representations of the corresponding false color images described above and are to the scale shown in the imagery. The results shown in these images and in the corresponding tables indicate that an increased addition of low MW poly(tetramethyl-p-silphenylenesiloxane) polymers increases wear of the article. Each of these figures represents a cross section of the test sample surface having a surface profile (300) digitally characterizing the polymer surface and divided by separation lines (302a, 302b) separating the surface profile (300) into an abraded region (304) (corresponding to abraded region (200) in the false color imagery) disposed between pristine regions (306a, 306b) (corresponding to pristine region (200) in the false color imagery). To enable measurements, the one or more maximums (300a, 300b, etc.) of the surface profile (300) are used to define and/or estimate a baseline (308) corresponding to the pre-testing pristine surface and positioned to enable the calculation of a cross-sectional wear area value (310) quantifying and providing a numerical value for the magnitude of the wear experienced between the baseline (308) and the corresponding surface profile (300) within the abraded region (304). As can be appreciated, these aspects of FIGS. 2B, 2E, 2H, 3B, 3E, and 3H show that increasing concentration of low molecular weight PTMPS (26K Da) in the high molecular weight PTMPS (287K Da) matrix leads to high wear cross-sectional areas as represented by the calculated wear area value (310) which represent inferior wear resistance in some test samples. It is submitted that these results show that the increasing presence of low molecular weight, oligomers and monomers in the article will result in inferior wear performance.

FIGS. 2C, 2F, 2I show the level of particulation on the Si₃N₄ countersurface after the end of the measurements which are normal for a load of 5 N applied to poly(tetramethyl-p-silphenylenesiloxane) polymers. FIGS. 3C, 3F, 3I show the level of particulation on the Si₃N₄ countersurface after the end of the measurements for a load of 10 N applied to poly(tetramethyl-p-silphenylenesiloxane) polymers. Each of these figures are generated at the magnification shown in the imagery. Each of these figures shows a Si₃N₄ countersurface holder (404), Si₃N₄ countersurface (402) and one or more abrasion particles (400) acquired from the polymer surface during the testing and indicating the degree of wear experienced. As can be appreciated, these aspects of FIGS. 2C, 2F, 2I, 3A, 3D, and 3G show that increasing concentration of low molecular weight PTMPS (26K Da) in the high molecular weight PTMPS (287K Da) matrix leads to inferior wear performance of the article with increasing particulate matter being removed and disposed on the countersurface.

Example 7: Table 4 compares the effects of cleaning the polymer of low Mw weight and oligomers of PTMS on the coefficient of friction and wear volume. Reducing the amount of oligomers and low molecular weight species via a “cleaning” process (finished polymer) resulted in significantly improved wear performance of the finished polymer compared to its raw state.

The samples in Table 4 were prepared according to the same procedure outlined in Example 6.

Example 8: This example compares SEM images of the Si₃N₄ countersurface after measuring the wear of a poly(tetramethyl-p-silphenylenesiloxane) polymer and an ultra-high molecular weight polyethylene polymer according to the Test Methods described herein.

FIG. 3J is an SEM image showing a transfer layer adhered to the Si₃N₄ countersurface after measuring the wear of a poly(tetramethyl-p-silphenylenesiloxane) polymer including 100 wt. % of a 650,000 Da polymer with 10 N of normal force. As shown, the poly(tetramethyl-p-silphenylenesiloxane) polymer forms a transfer layer 320 adhered to the Si₃N₄ countersurface after the test.

FIG. 3K is an SEM image showing the level of particulation on the Si₃N₄ countersurface after measuring the wear of an ultra-high molecular weight polyethylene polymer including 100 wt. % of a 2,063,000 Da polymer with 10 N of normal force. As shown, the ultra-high molecular weight polyethylene polymer forms particle agglomerates on the Si₃N₄ countersurface after the test.

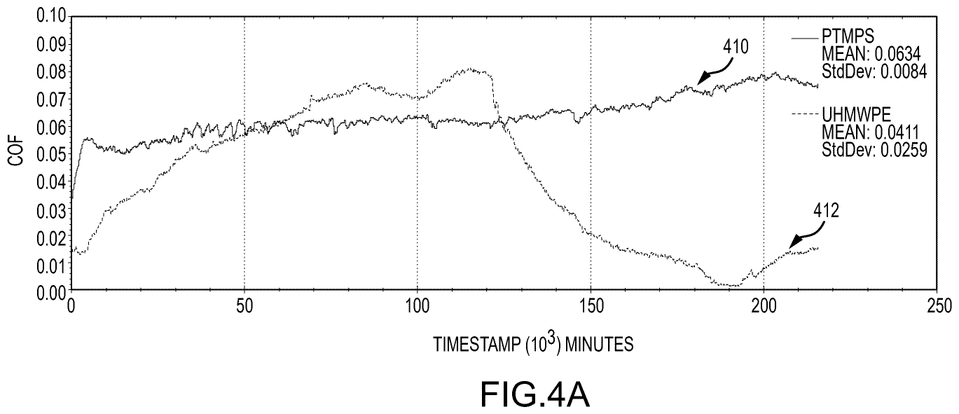

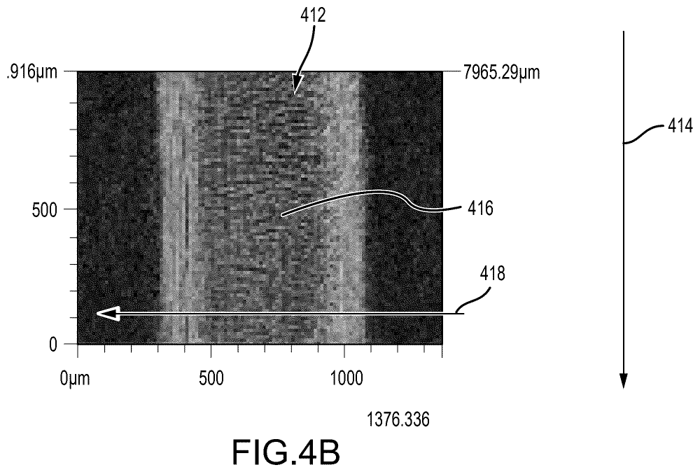

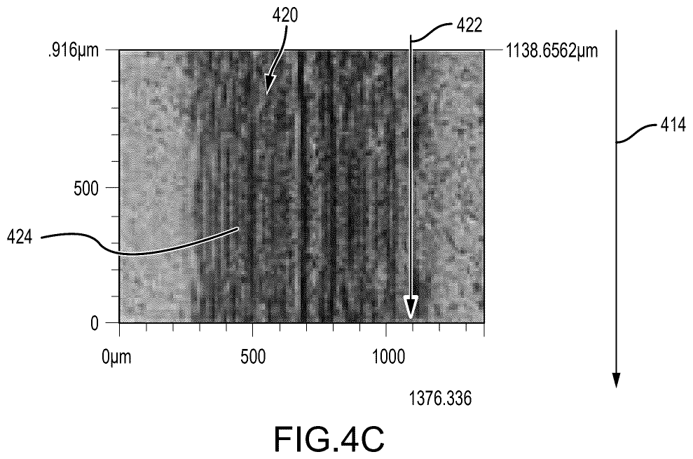

Example 9: Illustrated in FIG. 4A is a comparison of the coefficients of friction (COF, y-axis) as function of testing time (x-axis) for two materials: a poly(tetramethyl-p-silphenylenesiloxane) (PTMPS) polymer including 100 wt. % of a 3,300,000 Da polymer and an ultra-high molecular weight polyethylene (UHMWPE) polymer including 100 wt. % of a 2,063,000 Da polymer. The coefficients of friction were measured using a pin-on-disk test against a stainless steel pin at a temperature of from 20° C. to 22° C. for a period of about 60 hours at a sliding speed of from 0.4 to 0.5 ft/min, a rotation of about 2 rpm and a pressure of about 25000 Psi under a normal load of about 10 N using a tribometer, and were calculated according to the above referred Test Methods. The duration of the testing time was 60 hours. Line 410 represents the coefficient of friction of the PTMPS polymer having a mean value of 0.0634 and a standard deviation of 0.0084. Line 412 represents the coefficient of friction of the UHMWPE polymer having a mean value of 0.0411 and a standard deviation of 0.0259.

The PTMPS polymer sample has a coefficient of friction stable over a time period of sixty hours of wear testing. The maximum coefficient of friction for PTMPS was about 0.08 and the minimum was about 0.034. The coefficient remains within a deviation range of about ±40% over a time period of about 60 hours during the pin-on-disk test calculated by subtracting the maximum/minimum coefficient by the mean value, then divided by the mean value for PTMPS.

The UHMWPE polymer sample has a coefficient of friction spanning a larger range over the time period of sixty hours of wear testing. The maximum coefficient of friction for UHMWPE was about 0.08 and the minimum was about 0.002. The coefficient remains within a deviation range of about +100% over a time period of about 60 hours during the pin-on-disk test calculated by subtracting the maximum/minimum coefficient by the mean value, then divided by the mean value for UHMWPE.

FIG. 4B is an image showing the surface wear of a poly(tetramethyl-p-silphenylenesiloxane) polymer including 100 wt. % of a 3,300,000 Da polymer after a pin-on-disk test with 10 N of normal force against a stainless steel ball. As shown, the PTMPS polymer surface includes a wear track 412 along a direction of wear 414, the wear track 412 formed by the countersurface of the disk engaging the surface of the polymer block along the direction of wear. The wear track 412 further includes a number of wear patterns 416 along a direction of wear pattern 418. As shown, the direction of wear pattern 418 is substantially perpendicular to the direction of wear track 412.

FIG. 4C is an image showing the surface wear of an ultra-high molecular weight polyethylene polymer including 100 wt. % of a 2,063,000 Da polymer after a pin-on-disk test with 10 N of normal force against a stainless steel ball. As shown, the UHMWPE polymer surface includes a wear track 420 along a direction of wear 414, the wear track 420 formed by the countersurface of the disk engaging the surface of the UHMWPE polymer block along the direction of wear. The wear track 420 further includes a number of wear patterns 422 along a direction of wear pattern 424. As shown, the direction of wear pattern 424 is substantially along the direction of wear track 420.

Example 10: FIG. 5A is an image showing a transfer layer adhered to a hardened steel countersurface after measuring the wear of a poly(tetramethyl-p-silphenylenesiloxane) polymer against the countersurface. The poly(tetramethyl-p-silphenylenesiloxane) polymer including 100 wt. % of a 400,000 Da polymer was tested using the block-on-disk test described herein. As shown, the countersurface 502 includes a wear track 504 and a transfer layer 506 adhered to the countersurface 502 along the wear track 504. The transfer layer is of a white color distinct from the metallic color of the steel countersurface 502. The countersurface 502 also includes non-agglomerated poly(tetramethyl-p-silphenylenesiloxane) polymer particles 508 on the side of the wear track 504.

FIG. 5B is an image showing the surface wear of a poly(tetramethyl-p-silphenylenesiloxane) polymer including 100 wt. % of a 400,000 Da polymer after the block-on-disk test described herein. The block-on-disk test was conducted against a hardened steel countersurface along direction 510b. As shown, the surface of the poly(tetramethyl-p-silphenylenesiloxane) polymer includes wear tracks 504 substantially along the wear direction 510b. Worn poly(tetramethyl-p-silphenylenesiloxane) polymer particles 506 form along the sides of the wear track in a direction perpendicular to the direction of wear track. As shown, most of the worn polymer particles 506 formed during the test do not agglomerate and are of particulate appearance.

Comparative Example 11: FIG. 6A is an image showing a hardened steel countersurface 602 after measuring the wear of ultra-high molecular weight polyethylene polymer including 100 wt. % of a 2,063,000 Da polymer. No visible transfer layer was observed on the countersurface 602. The color of the countersurface 602 was of a substantially uniform metallic color from the steel material. Agglomeration of UHMWPE polymer particles 612 were observed on the wear track 604 along the direction 610a.

FIG. 6B is an image showing the surface wear of an ultra-high molecular weight polyethylene polymer including 100 wt. % of a 2,063,000 Da polymer after the block-on-disk test described herein. The block-on-disk test was conducted against a hardened steel countersurface along direction 610b. As shown, the surface of the ultra-high molecular weight polyethylene polymer includes wear tracks 604 substantially along the wear direction 610b. Worn ultra-high molecular weight polyethylene polymer particles 606 form mostly on the trailing end of the wear tracks 604 along the wear direction 610b.

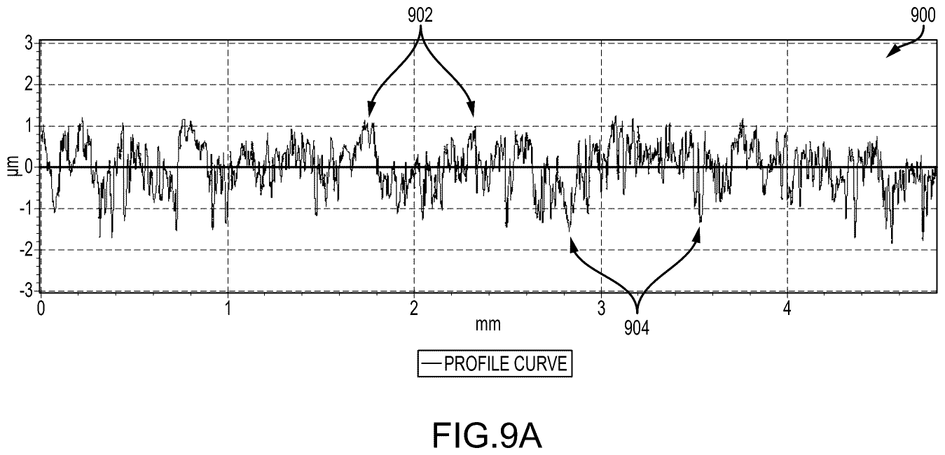

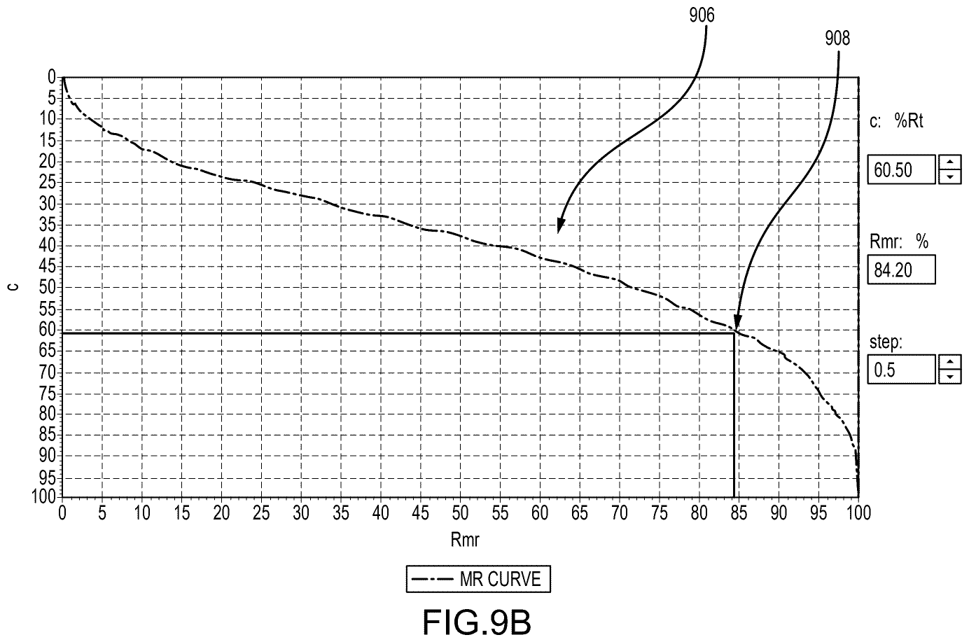

Comparative Example 12: FIG. 9A is a surface profile curve 900 of a clean hardened steel countersurface used in a block-on-disk test. As shown, the clean countersurface has a surface profile including a textured topography characterized by a plurality of irregular protrusions 902 and depressions 904 on the surface profile curve 900.

FIG. 9B is an Abbott-Firestone curve 906 of the clean hardened steel countersurface in FIG. 9A. The curve 906 is of a sigmoid shape and has an Rku value of 2.569 calculated using methods described herein. Each point on the curve 906 shows a percentage of a surface's material (x-axis) that would contact a flat plane at a certain depth (y-axis). For example, point 908 on the curve 906 shows that about 84% of material contacts a flat plate at a depth of about 61%.

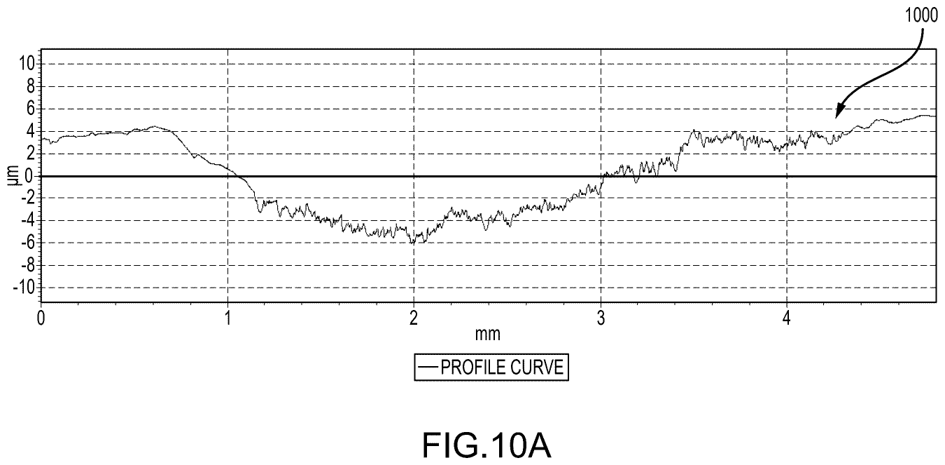

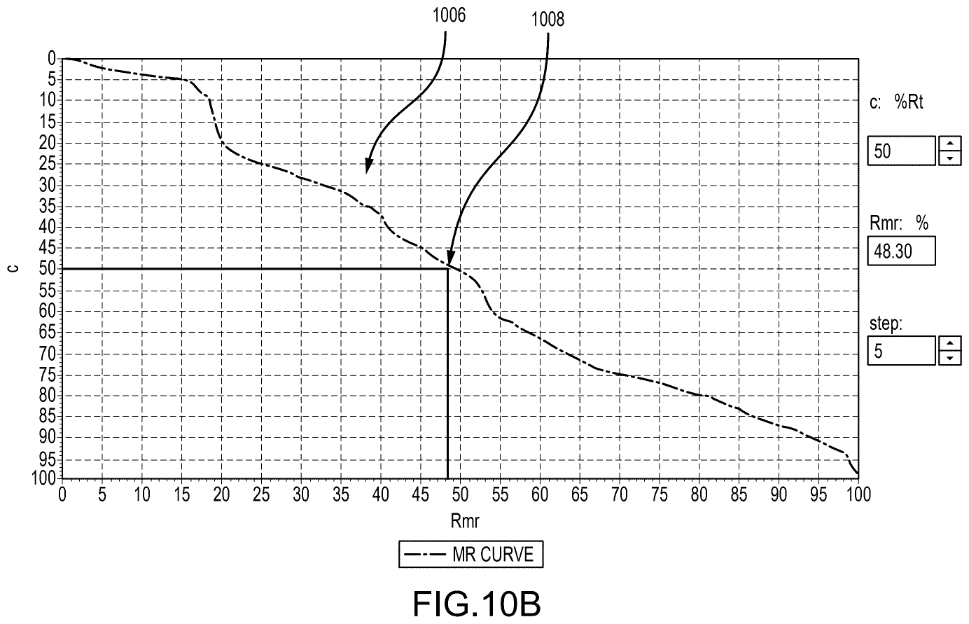

Example 13: FIG. 10A is a profile curve 1000 of a hardened steel countersurface used in a block-on-disk test against a poly(tetramethyl-p-silphenylenesiloxane) polymer including 100 wt. % of a 3,300,000 Da polymer. As shown, the surface profile curve 1000 is of a different shape from the clean surface profile curve 900, suggesting the deposition of a transfer layer including poly(tetramethyl-p-silphenylenesiloxane) polymer particles onto the hardened steel countersurface during the test.

FIG. 10B an Abbott-Firestone curve 1006 of the hardened steel countersurface in FIG. 10A. The curve 1006 is not of a sigmoid shape and has an Rku value of 1.379 calculated using methods described herein. Each point on the curve 1006 shows a percentage of a surface's material (x-axis) that would contact a flat plane at a certain depth (y-axis). For example, point 1008 on the curve 1006 shows that about 48% of material contacts a flat plate at a depth of about 50%.

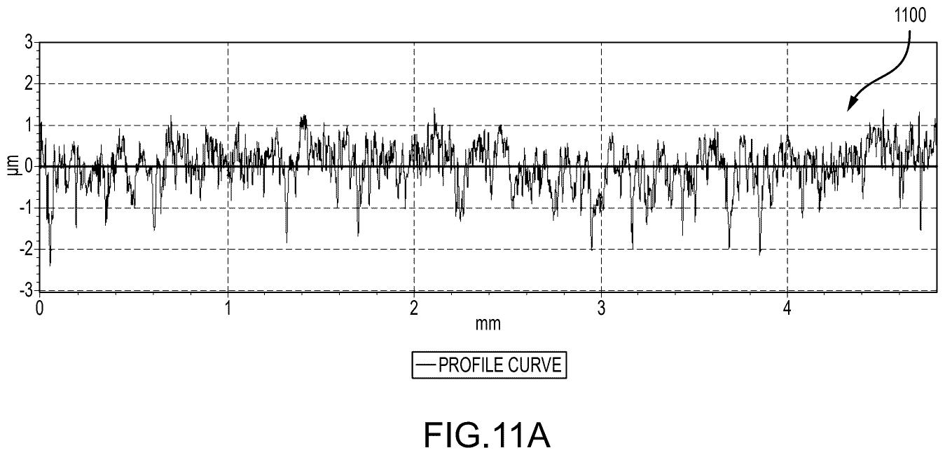

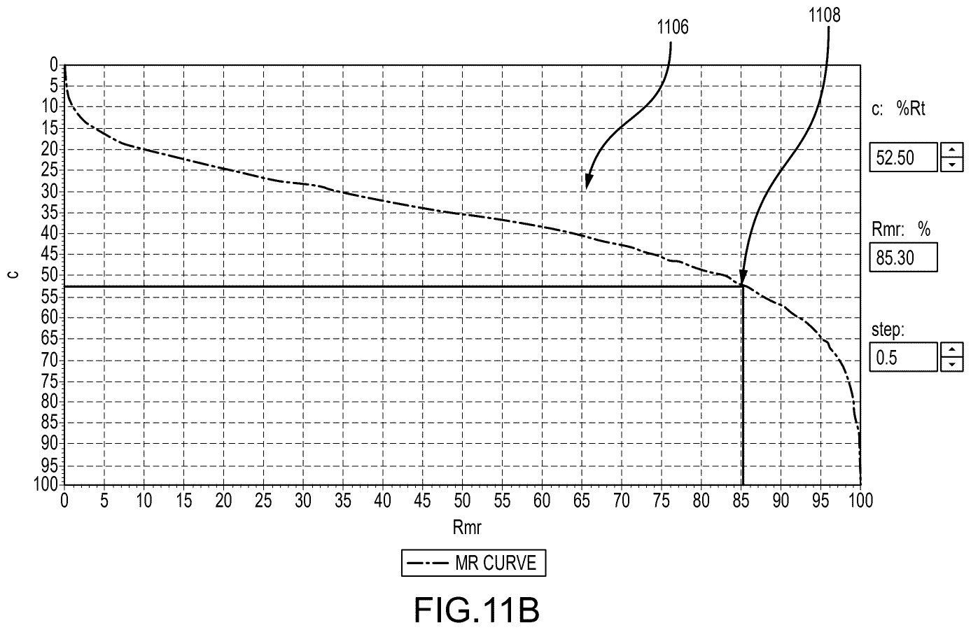

Comparative Example 14: FIG. 11A is a profile curve of a hardened steel countersurface used in a block-on-disk test against an ultra-high molecular weight polyethylene polymer including 100 wt. % of a 2,063,000 Da polymer. As shown, the surface profile curve 1100 is of a similar shape to the clean surface profile curve 900, suggesting the lack of a transfer layer forming on the hardened steel countersurface during the test.

FIG. 11B is an Abbott-Firestone curve 1106 of the hardened steel countersurface in FIG. 11A. The curve 1106 is of a sigmoid shape and has an Rku value of 3.661 calculated using methods described herein. Each point on the curve 1106 shows a percentage of a surface's material (x-axis) that would contact a flat plane at a certain depth (y-axis). For example, point 1108 on the curve 1106 shows that about 85% of material contacts a flat plate at a depth of about 52.5%.

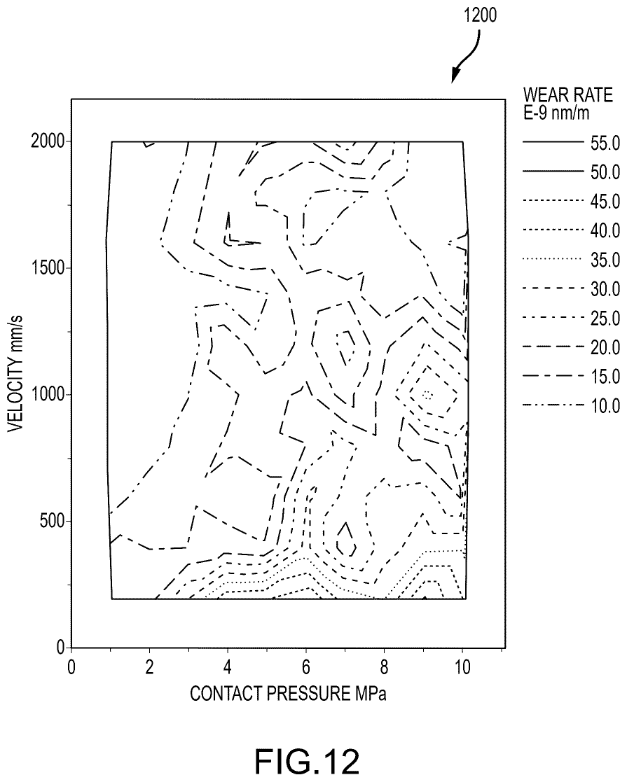

Example 15: FIG. 12 is a surface wear contour plot 1200 showing the surface wear of a poly(tetramethyl-p-silphenylenesiloxane) polymer including 100 wt. % of a 400,000 Da polymer after a block-on-disk test described herein. As shown, the specific wear rate is less than 10 nm/m at a pressure*velocity value of from about 14,000 to about 20,000 MPa*mm/s and less than 20 nm/m at a pressure*velocity value of from about 12,000 to about 20,000 MPa*mm/s.

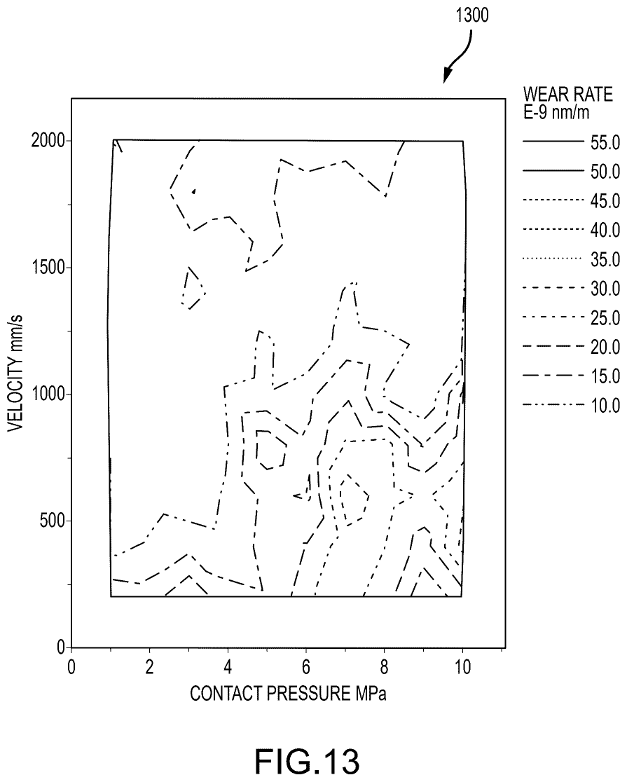

Example 16: FIG. 13 is a surface wear contour plot 1300 showing the surface wear of a poly(tetramethyl-p-silphenylenesiloxane) polymer including 100 wt. % of a 3,300,000 Da polymer after a block-on-disk test. As shown, the specific wear rate is less than 10 nm/m at a pressure*velocity value of from about 14,000 to about 20,000 MPa*mm/s and is less than 35 nm/m at a pressure*velocity value of from about 200 to about 20,000 MPa*mm/s.

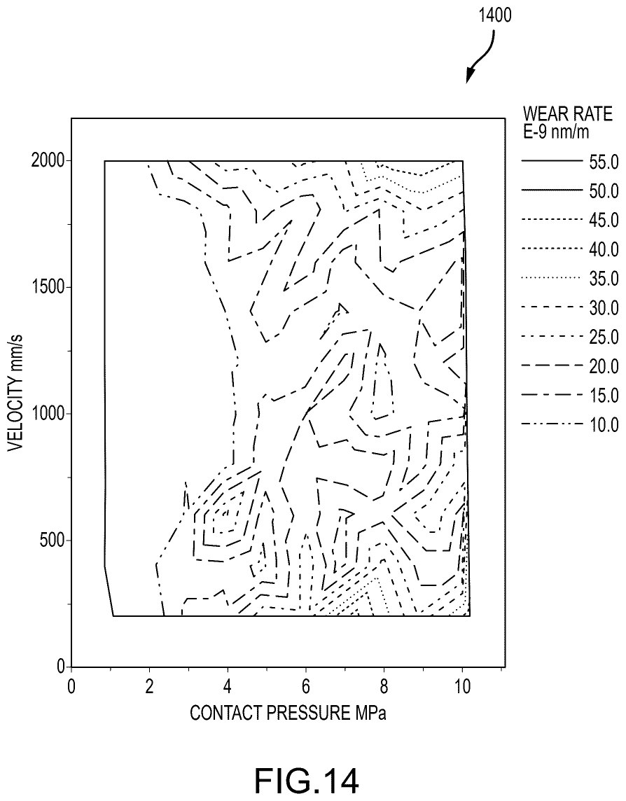

Comparative Example 17: FIG. 14 is a surface wear contour plot 1400 showing the surface wear of an ultra-high molecular weight polyethylene polymer including 100 wt. % of a 2,063,000 Da polymer using a block-on-disk test. As shown, the specific wear rate is greater than 15 nm/m at a pressure*velocity value of from about 14,000 to about 20,000 MPa*mm/s.

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalent.

### Aspects

Aspect 1 is a polymer composition comprising: a siloxane polymer with repeat units of the following general Formula 3:

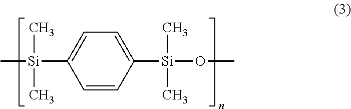

wherein n is any integer from 5 to 50,000; and wherein the polymer composition comprises an amount of oligomers having a molecular weight of less than 20,000 Da of from 0.1% to 10% as determined by gel permeation chromatography.

Aspect 2 is the polymer composition of Aspect 1, wherein n is from 200 to 25,000; and wherein the siloxane polymer has a weight average molecular weight from 50,000 Da to 5,000,000 Da.

Aspect 3 is the polymer composition of Aspect 1 or Aspect 2, wherein n is from 300 to 3800; and wherein the siloxane polymer has a weight average molecular weight of from 70,000 Da to 800,000 Da.

Aspect 4 is the polymer composition of any one of Aspects 1 to 3, wherein n is from 50 to 250; and wherein the siloxane polymer has a weight average molecular weight from 10,000 Da to 50,000 Da.

Aspect 5 is the polymer composition of any one of Aspects 1 to 4, wherein the siloxane polymer has a molecular weight polydispersity of less than or equal to 10.

Aspect 6 is the polymer composition of any one of Aspects 1 to 5, wherein the siloxane polymer has a molecular weight polydispersity of less than or equal to 2.

Aspect 7 is the polymer composition of any one of Aspects 1 to 6, wherein the siloxane polymer has a crystallinity of about 20% or greater.

Aspect 8 is the polymer composition of any one of Aspects 1 to 7, wherein the siloxane polymer has a ratio of surface crystallinity:interior crystallinity from 1.1:1 to 10:1.

Aspect 9 is the polymer composition of any one of Aspects 1 to 8, further comprising a second polymer different from the siloxane polymer of formula (3).

Aspect 10 is the polymer composition of Aspect 9, wherein the siloxane polymer is present in an amount of from 10 wt. % to 90 wt. %, based on a total weight of the polymer composition.

Aspect 11 is the polymer composition of Aspect 9, wherein the second polymer is a homopolymer.

Aspect 12 is the polymer composition of Aspect 9, wherein the second polymer is a copolymer.

Aspect 13 is a polymer composition comprising: a siloxane polymer with repeat units of the following general Formula 3:

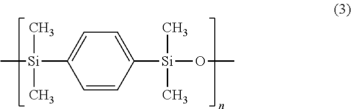

wherein n is any integer from 40 to 50,000; and wherein the siloxane polymer has a molecular weight polydispersity of less than or equal to 10.

Aspect 14 is the polymer composition of Aspect 13, wherein n is from 200 to 25,000; and wherein the siloxane polymer has a weight average molecular weight from 50,000 Da to 5,000,000 Da.

Aspect 15 is the polymer composition of Aspect 13 or Aspect 14, wherein n is from 300 to 3800; and wherein the siloxane polymer has a weight average molecular weight of from 70,000 Da to 800,000 Da.

Aspect 16 is the polymer composition of Aspects 13 or 14, wherein n is from 50 to 250; and wherein the siloxane polymer has a weight average molecular weight from 10,000 Da to 50,000 Da.

Aspect 17 is the polymer composition of any one of Aspects 13 to 16 wherein the siloxane polymer has a molecular weight polydispersity of less than or equal to 2.

Aspect 18 is the polymer composition of any one of Aspects 13 to 17, wherein the polymer composition comprises an amount of oligomers having a molecular weight of from 450 to 20,000 Da of from 0.1% to 10% as determined by gel permeation chromatography.

Aspect 19 is the polymer composition of any one of Aspects 13 to 18, wherein the siloxane polymer has a crystallinity of about 20% or greater.

Aspect 20 is the polymer composition of any one of Aspects 13 to 19, wherein the siloxane polymer has a ratio of surface crystallinity:interior crystallinity from 1.1:1 to 10:1.

Aspect 21 is a polymer composition comprising: a siloxane polymer with repeat units of the following general Formula 3:

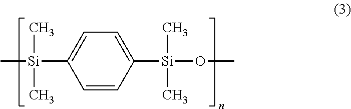

wherein n is any integer from 40 to 50,000, wherein the polymer composition comprises an amount of oligomers having a molecular weight of from 450 to 20,000 Da of from 0.1% to 10% as determined by gel permeation chromatography; and wherein the siloxane polymer has a molecular weight polydispersity of less than or equal to 10.

Aspect 22 is the polymer composition of Aspect 21, wherein n is from 200 to 25,000; and wherein the siloxane polymer has a weight average molecular weight from 50,000 Da to 5,000,000 Da.

Aspect 23 is the polymer composition of Aspect 21 or Aspect 22, wherein n is from 300 to 3800; and wherein the siloxane polymer has a weight average molecular weight of from 70,000 Da to 800,000 Da.

Aspect 24 is the polymer composition of any one of Aspects 21 to 23, wherein n is from 50 to 250; and wherein the siloxane polymer has a weight average molecular weight from 10,000 Da to 50,000 Da.

Aspect 25 is the polymer composition of any one of Aspects 21 to 24, wherein the siloxane polymer has a molecular weight polydispersity of less than or equal to 2.

Aspect 26 is the polymer composition of any one of Aspects 21 to 25, wherein the siloxane polymer has a crystallinity of about 20% or greater.

Aspect 27 is the polymer composition of any one of Aspects 21 to 26, wherein the siloxane polymer has a ratio of surface crystallinity:interior crystallinity from 1.1:1 to 10:1.

Aspect 28 is a polymer composition comprising: a siloxane polymer with repeat units of the following general Formula 1:

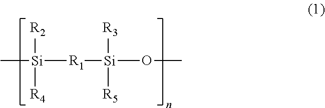

wherein R₁, R₂, R₃, R₄, and R₅ are selected from alkyl groups having 1 to 20 carbon atoms, branched alkyl groups having 3 to 20 carbon atoms, cyclic alkyl groups having 3 to 20 carbon atoms, alkenyl groups having 2 to 20 carbon atoms, alkynyl groups having 2 to 20 carbon atoms, aromatic ring systems having 6 to 40 aromatic ring atoms, and heteroaromatic ring systems having 5 to 40 aromatic ring atoms; wherein n is any integer from 2 to 100,000; and wherein the polymer composition comprises an amount of oligomers having a molecular weight from 450 Da to 20,000 Da of from 0.1% to 4% as determined by gel permeation chromatography.

Aspect 29 is the polymer composition of Aspect 28, wherein n is from 200 to 25,000; and wherein the siloxane polymer has a weight average molecular weight from 50,000 Da to 5,000,000 Da.

Aspect 30 is the polymer composition of Aspect 28 or Aspect 29, wherein n is from 300 to 3800; and wherein the siloxane polymer has a weight average molecular weight of from 70,000 Da to 800,000 Da.

Aspect 31 is the polymer composition of any one of Aspects 28 to 30, wherein n is from 50 to 250; and wherein the siloxane polymer has a weight average molecular weight from 10,000 Da to 50,000 Da.

Aspect 32 is the polymer composition of any one of Aspects 28 to 31, wherein the siloxane polymer has a molecular weight polydispersity of less than or equal to 10.

Aspect 33 is the polymer composition of any one of Aspects 28 to 32, wherein the siloxane polymer has a molecular weight polydispersity of less than or equal to 2.

Aspect 34 is the polymer composition of any one of Aspects 28 to 33, wherein the siloxane polymer has a crystallinity of about 20% or greater.

Aspect 35 is the polymer composition of any one of Aspects 28 to 34, wherein the siloxane polymer has a ratio of surface crystallinity:interior crystallinity from 1.1:1 to 10:1.

Aspect 36 is the polymer composition of any one of Aspects 28 to 35, further comprising a second polymer different from the siloxane polymer of formula (1).

Aspect 37 is the polymer composition of Aspect 36, wherein the siloxane polymer is present in an amount of from 10 wt. % to 90 wt. %, based on a total weight of the polymer composition.

Aspect 38 is the polymer composition of Aspect 36, wherein the second polymer is a homopolymer.

Aspect 39 is the polymer composition of Aspect 36, wherein the second polymer is a copolymer.

Aspect 40 is the polymer composition of any one of Aspects 28 to 39, wherein the polymer composition comprises an amount of oligomers having a molecular weight from 450 Da to 10,000 Da of from 0.1% to 4% as determined by gel permeation chromatography.

Aspect 41 is a polymer composition comprising: a siloxane polymer with repeat units of the following general Formula 3:

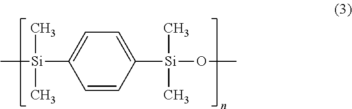

wherein n is any integer from 40 to 50,000, wherein the siloxane polymer provides a constant average coefficient of friction over a time period of sixty minutes of wear testing; and wherein the coefficient of friction is measured using a pin-on-disk test against Si₃N₄ at room temperature for a period of 1 hour at a sliding speed of 1 mm/s, a sliding distance of 14 mm, a rotation of 1 rpm and a static pressure of 15 N using a tribometer.

Aspect 42 is the polymer composition of Aspect 41, wherein the constant average coefficient of friction is approximately 0.013.

Aspect 43 is an article comprising the polymer composition of any of Aspects 1 to 42.

Aspect 44 is the article of Aspect 43, wherein the article has a coefficient of friction of less than 0.02.

Aspect 45 is the article of Aspect 43 or Aspect 44, wherein the article has a coefficient of friction of less than 0.04.

Aspect 46 is the article of any one of Aspects 43 to 45, wherein the article has a combination of low friction and low wear rate, as expressed in the form of a product of a friction coefficient μ times a wear rate, κ, of less than 4×10⁻⁶ mm³/mN.

Aspect 47 is the article of any one of Aspects 43 to 46, wherein the article has a combination of low friction and low wear rate, as expressed in the form of a product of a friction coefficient μ times a wear rate, κ, of greater than 10⁻¹⁰ mm³/mN and less than 4×10⁻⁶ mm³/mN.

Aspect 48 is the article of any one of Aspects 43 to 47, wherein the polymer composition has a crystallinity of about 20% or greater.

Aspect 49 is the polymer composition of any one of Aspects 43 to 48, wherein the siloxane polymer has a ratio of surface crystallinity:interior crystallinity from 1.1:1 to 10:1.

Aspect 50 is the article of any one of Aspects 43 to 49, wherein the article has a surface roughness of from 0.08 μm to 0.2 μm.

Aspect 51 is a method for preparing a polymer composition, the method comprising: (i) polymerizing monomers of the general Formula (4) to form a polymer:

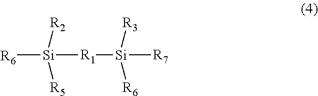

wherein R₁, R₂, R₃, R₄, and R₅ are selected from alkyl groups having 1 to 20 carbon atoms, alkenyl or alkynyl groups having 2 to 20 carbon atoms, aromatic ring systems having 6 to 40 aromatic ring atoms, and heteroaromatic ring systems having 5 to 40 aromatic ring atoms; wherein R₆ and R₇ may be the same or different at each instance and are selected from hydroxyl groups, alkoxy groups, hydrogen, and halogens; and (ii) immersing the polymer from step (i) in a solvent to remove oligomers from the polymer.

Aspect 52 is the method of Aspect 51, wherein the solvent is selected from toluene, xylene, methanol, tetrahydrofuran, or benzene.

Aspect 53 is the method of Aspect 51 or Aspect 52, wherein the oligomers have a molecular weight of from 450 Da to 10,000 Da as determined by gel permeation chromatography.

Aspect 54 is the method of any one of Aspects 51 to 53, wherein the polymer composition comprises an amount of oligomers having a molecular weight from 450 Da to 20,000 Da of from 0.1% to 4% as determined by gel permeation chromatography.

Aspect 55 is the method of any one of Aspects 51 to 54, wherein the polymer composition comprises an amount of oligomers having a molecular weight from 450 Da to 10,000 Da of from 0.1% to 4% as determined by gel permeation chromatography.

Aspect 56 is a method for preparing a polymer composition, the method comprising: (i) polymerizing monomers of the general Formula (5) to form a polymer:

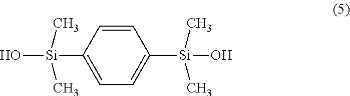

and (ii) immersing the polymer from step (i) in a solvent to remove oligomers from the polymer.

Aspect 57 is the method of Aspect 56, wherein the solvent is selected from toluene, xylene, methanol, tetrahydrofuran, or benzene.

Aspect 58 is the method of Aspect 56 or Aspect 57, wherein the oligomers have a molecular weight of from 450 Da to 20,000 Da as determined by gel permeation chromatography.

Aspect 59 is the method of any one of Aspects 56 to 58, wherein the polymer composition comprises an amount of oligomers having a molecular weight from 450 Da to 20,000 Da of from 0.1% to 4% as determined by gel permeation chromatography.

Aspect 60 is the method of any one of Aspects 56 to 59, wherein the polymer composition comprises an amount of oligomers having a molecular weight from 450 Da to 10,000 Da of from 0.1% to 4% as determined by gel permeation chromatography.

Aspect 61 is a polymer composition comprising: a poly(tetramethyl-p-silphenylenesiloxane) (PTMPS) polymer having a weight average molecular weight of from 10,000 Da to 3,000,000 Da; wherein the PTMPS polymer provides a coefficient of friction stable over a time period of sixty hours of wear testing; and wherein the coefficient of friction is measured using a pin-on-disk test at a temperature of from 20° C. to 22° C. for a period of about 60 hours at a sliding speed of from 0.4 to 0.5 ft/min, a rotation of about 2 rpm and a pressure of about 25000 Psi under a normal load of about 10 N using a tribometer.

Aspect 62 is the polymer composition of Aspect 61, wherein the coefficient of friction remains within a deviation range of from about 20% to about 50% over a time period of about 60 hours during the pin-on-disk test.

Aspect 63 is the polymer composition of Aspects 61 or 62, wherein the pin-on-disk test is conducted against a stainless steel pin.

Aspect 64 is the polymer composition of any one of Aspects 61 to 63, wherein the coefficient of friction has a standard deviation of less than 0.02.

Aspect 65 is the polymer composition of any one of Aspects 61 to 64, wherein the coefficient of friction has a standard deviation is less than 0.01.

Aspect 66 is the polymer composition of any one of Aspects 61 to 65, wherein the PTMPS polymer has a weight average molecular weight of less than about 3,000,000 Da.

Aspect 67 is the polymer composition of any one of Aspects 61 to 66, wherein the PTMPS polymer has a weight average molecular weight of less than about 2,000,000 Da.

Aspect 68 is the polymer composition of any one of Aspects 61 to 67, wherein the PTMPS polymer has a weight average molecular weight of from about 500,000 Da to about 1,500,000 Da.

Aspect 69 is the polymer composition of any one of Aspects 61 to 68, wherein the coefficient of friction has an average coefficient of friction of from about 0.05 to about 0.08.

Aspect 70 is a polymer composition comprising: a poly(tetramethyl-p-silphenylenesiloxane) (PTMPS) polymer having a weight average molecular weight from 50,000 Da to 5,000,000 Da; wherein the PTMPS polymer provides a specific wear rate as determined using a block-on-disk test against a countersurface of a disk at a pressure of from 1 MPa to 10 MPa, a velocity of 200 mm/s to 2000 mm/s, and a contact radius of about 80 mm for a sliding distance of about 0.5 m/rev; wherein the specific wear rate is calculated by dividing a change in laser displacement measurement by a change in sliding distance during the block-on-disk test.

Aspect 71 is the polymer composition of Aspect 70, wherein the disk is a hardened steel disk.

Aspect 72 is the polymer composition of Aspects 70 or 71, wherein the specific wear rate is less than 10 nm/m at a pressure*velocity value of from about 14,000 to about 20,000 MPa*mm/s.

Aspect 73 is the polymer composition of Aspects 70 or 71, wherein the weight average molecular weight is from 1,000,000 Da to 5,000,000 Da; wherein the specific wear rate is less than 35 nm/m at a pressure*velocity value of from about 200 to about 20,000 MPa*mm/s.

Aspect 74 is the polymer composition of Aspects 70 or 71, wherein the weight average molecular weight is from 50,000 Da to 1,000,000 Da; wherein the specific wear rate is less than 20 nm/m at a pressure*velocity value of from about 12,000 to about 20,000 MPa*mm/s.

Aspect 75 is the polymer composition of any one of Aspects 70 to 74, wherein the composition produces a plurality of particles deposited on at least a portion of the countersurface during the block-on-disk test, the particles forming a transfer layer adhered to the countersurface.

Aspect 76 is the polymer composition of Aspect 75, wherein the countersurface has a surface profile prior to the block-on-disk test, the surface profile including a textured topography characterized by a plurality of irregular protrusions and depressions; wherein the PTMPS polymer particles of the transfer layer at least partially fill in the depressions formed between adjacent protrusions, conforming to the textured topography of the countersurface.

Aspect 77 is the polymer composition of Aspects 75 or 76, wherein the transfer layer adheres to the countersurface via physical bonding between the PTMPS polymer particles and the countersurface.

Aspect 78 is a wear engagement system comprising: a polymeric surface comprising a poly(tetramethyl-p-silphenylenesiloxane) (PTMPS) polymer; and a modified countersurface engaging the polymeric surface at a pressure of from 1 MPa to 10 MPa, a velocity of 200 mm/s to 2000 mm/s, and a contact radius of about 80 mm for a sliding distance of about 0.5 m/rev, wherein the modified countersurface comprises an original countersurface of a disk and a transfer layer formed of particles shed from the polymeric surface comprising particles of the PTMPS polymer during an initial wear period of the wear engagement system.

Aspect 79 is the polymer composition of Aspects 76 or 77, wherein the first surface profile generates a first Abbott-Firestone curve by plotting a first cumulative probability density function of the first surface profile's height; wherein the second surface profile generates a second Abbott-Firestone curve by plotting a second cumulative probability density function of the second surface profile's height; wherein the first Abbott-Firestone curve is dissimilar to the second Abbott-Firestone curve.

Aspect 80 is the polymer composition of any one of Aspects 76 to 83, wherein the first Abbott-Firestone curve includes about 1% material ratio as defined on an x-axis of the first Abbott-Firestone curve at about 5% depth as defined on a y-axis of the second Abbott-Firestone curve.

Aspect 81 is the polymer composition of any one of Aspects 76 to 84, wherein the second Abbott-Firestone curve includes about 15% material ratio as defined on an x-axis of the second Abbott-Firestone curve at about 5% depth as defined on a y-axis of the second Abbott-Firestone curve.

Aspect 82 is the polymer composition of any one of Aspects 76 to 85, wherein the second Abbott-Firestone curve includes about 14% more material ratio at about 5% depth compared to the first Abbott-Firestone curve.

Aspect 83 is an article comprising: a polymer block comprising a poly(tetramethyl-p-silphenylenesiloxane) (PTMPS) polymer with repeat units of the following general Formula 3:

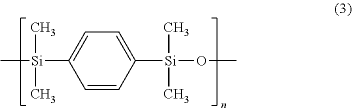

a wear track along a direction of wear track on a surface of the polymer block after the article is subject to a block-on-disk test against a countersurface of a disk at a pressure of from 1 MPa to 10 MPa, a velocity of 200 mm/s to 2000 mm/s, and a contact radius of about 80 mm for a sliding distance of about 0.5 m/rev; and worn PTMPS polymer particles substantially along the sides of the wear track in a direction perpendicular to the direction of wear track; wherein n is any integer from 5 to 50,000; wherein the wear track is formed by the countersurface of the disk engaging the surface of the polymer block along the direction of wear track.

Aspect 84 is the article of Aspect 83, wherein the worn PTMPS polymer particles along the sides of the wear track do not agglomerate.

Aspect 85 is the article of Aspects 83 or 84, wherein the surface of the polymer block further comprises a wear pattern spanning at least a portion of the wear track, the wear pattern defining a direction of wear pattern; wherein the direction of wear pattern is substantially perpendicular to the direction of wear track.

Aspect 86 is a method of modifying a countersurface, the method comprising: disposing an unmodified countersurface to frictionally engage a surface of a polymer block comprising a poly(tetramethyl-p-silphenylenesiloxane) (PTMPS) polymer; transferring a plurality of PTMPS polymer particles from the surface of the polymer block to the countersurface during a frictional engagement; and modifying the countersurface to include an engaged transfer layer of the transferred PTMPS polymer particles fixedly deposited on the unmodified countersurface.

Aspect 87 is the method of Aspect 86, wherein the unmodified countersurface presents a first coefficient of friction and the modified countersurface presents a second coefficient of friction, the second coefficient of friction being less than the first coefficient of friction.

Aspect 88 is the PTMPS polymer of any one of the preceding Aspects, comprising repeat units of the following general Formula 3:

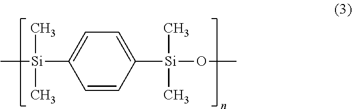

wherein n is any integer from 5 to 50,000.

Aspect 89 is the PTMPS polymer of any one of the preceding Aspects, comprising repeat units of the following general Formula 1:

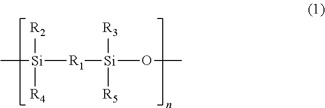

wherein R₁, R₂, R₃, R₄, and R₅ are selected from alkyl groups having 1 to 20 carbon atoms, branched alkyl groups having 3 to 20 carbon atoms, cyclic alkyl groups having 3 to 20 carbon atoms, alkenyl groups having 2 to 20 carbon atoms, alkynyl groups having 2 to 20 carbon atoms, aromatic ring systems having 6 to 40 aromatic ring atoms, and heteroaromatic ring systems having 5 to 40 aromatic ring atoms; wherein n is any integer from 2 to 100,000; and wherein the polymer composition comprises an amount of oligomers having a molecular weight from 450 Da to 20,000 Da of from 0.1% to 4% as determined by gel permeation chromatography.

Aspect 90 is the PTMPS polymer of any one of the preceding Aspects, comprising repeat units of the following general Formula 2:

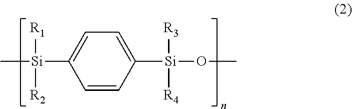

wherein R₁, R₂, R₃, R₄, and R₅ are selected from alkyl groups having 1 to 20 carbon atoms, branched alkyl groups having 3 to 20 carbon atoms, cyclic alkyl groups having 3 to 20 carbon atoms, alkenyl groups having 2 to 20 carbon atoms, alkynyl groups having 2 to 20 carbon atoms, aromatic ring systems having 6 to 40 aromatic ring atoms, and heteroaromatic ring systems having 5 to 40 aromatic ring atoms; wherein n is any integer from 2 to 100,000.

We claim:

1. A polymer composition comprising:
a siloxane polymer with repeat units of the following general Formula 3: 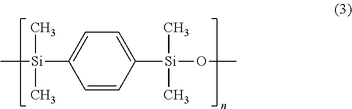
wherein n is any integer from 40 to 50,000,
wherein the polymer composition comprises an amount of oligomers having a molecular weight of from 450 to 20,000 Da of from 0.1% to 10% as determined by gel permeation chromatography; and
wherein the siloxane polymer has a molecular weight polydispersity of less than or equal to 10.

2. The polymer composition of claim 1, wherein n is from 200 to 25,000;
wherein the siloxane polymer has a weight average molecular weight from 50,000 Da to 5,000,000 Da.

3. The polymer composition of claim 1, wherein n is from 300 to 3800; and
wherein the siloxane polymer has a weight average molecular weight of from 70,000 Da to 800,000 Da.

4. The polymer composition of claim 1, wherein n is from 50 to 250; and
wherein the siloxane polymer has a weight average molecular weight from 10,000 Da to 50,000 Da.

5. The polymer composition of claim 1, wherein the siloxane polymer has a molecular weight polydispersity of less than or equal to 2.

6. The polymer composition of claim 1, wherein the siloxane polymer is present in an amount of from 10 wt. % to 90 wt. %, based on a total weight of the polymer composition.

7. A polymer composition comprising:
a siloxane polymer with repeat units of the following general Formula 3: 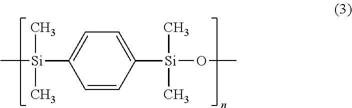
wherein n is any integer from 40 to 50,000,
wherein the siloxane polymer provides a constant average coefficient of friction over a time period of sixty minutes of wear testing; and
wherein the coefficient of friction is measured using a pin-on-disk test against Si₃N₄ at room temperature for a period of 1 hour at a sliding speed of 1 mm/s, a sliding distance of 14 mm, a rotation of 1 rpm and a static pressure of 15 N using a tribometer.

8. The polymer composition of claim 7, wherein the constant average coefficient of friction is approximately 0.013.

9. An article comprising the polymer composition of claim 1.

10. The article of claim 9, wherein the article has a coefficient of friction of less than 0.04.

11. The article of claim 9, wherein the article has a combination of low friction and low wear rate, as expressed in the form of a product of a friction coefficient μ times a wear rate, κ, of less than 4×10⁻⁶ mm³/mN.

12. The article of claim 9, wherein the article has a surface roughness of from 0.08 μm to 0.2 μm.

13. A polymer composition comprising:
a poly(tetramethyl-p-silphenylenesiloxane) (PTMPS) polymer having a weight average molecular weight of from 10,000 Da to 3,000,000 Da;
wherein the PTMPS polymer provides a coefficient of friction stable over a time period of sixty hours of wear testing; and
wherein the coefficient of friction is measured using a pin-on-disk test at a temperature of from 20° C. to 22° C. for a period of about 60 hours at a sliding speed of from 0.4 to 0.5 ft/min, a rotation of about 2 rpm and a pressure of about 25000 Psi under a normal load of about 10 N using a tribometer.

14. The polymer composition of claim 13, wherein the coefficient of friction remains within a deviation range of from about 20% to about 50% over a time period of about 60 hours during the pin-on-disk test.

15. The polymer composition of claim 13, wherein the PTMPS polymer has a weight average molecular weight of from about 500,000 Da to about 1,500,000 Da.

16. The polymer composition of claim 13, wherein the coefficient of friction has an average coefficient of friction of from about 0.05 to about 0.08.

17. A polymer composition comprising:
a poly(tetramethyl-p-silphenylenesiloxane) (PTMPS) polymer having a weight average molecular weight from 50,000 Da to 5,000,000 Da;
wherein the PTMPS polymer provides a specific wear rate as determined using a block-on-disk test against a countersurface of a disk at a pressure of from 1 MPa to 10 MPa, a velocity of 200 mm/s to 2000 mm/s, and a contact radius of about 80 mm for a sliding distance of about 0.5 m/rev;
wherein the specific wear rate is calculated by dividing a change in laser displacement measurement by a change in sliding distance during the block-on-disk test.

18. The polymer composition of claim 17, wherein the specific wear rate is less than 10 nm/m at a pressure*velocity value of from about 14,000 to about 20,000 MPa*mm/s.

19. The polymer composition of claim 17,
wherein the weight average molecular weight is from 1,000,000 Da to 5,000,000 Da;
wherein the specific wear rate is less than 35 nm/m at a pressure*velocity value of from about 200 to about 20,000 MPa*mm/s.

20. The polymer composition of claim 17,
wherein the weight average molecular weight is from 50,000 Da to 1,000,000 Da;
wherein the specific wear rate is less than 20 nm/m at a pressure*velocity value of from about 12,000 to about 20,000 MPa*mm/s.

21. The polymer composition of claim 17, wherein the composition produces a plurality of particles deposited on at least a portion of the countersurface during the block-on-disk test, the particles forming a transfer layer adhered to the countersurface.

22. The polymer composition of claim 21,
wherein the countersurface has a surface profile prior to the block-on-disk test, the surface profile including a textured topography characterized by a plurality of irregular protrusions and depressions;
wherein the PTMPS polymer particles of the transfer layer at least partially fill in the depressions formed between adjacent protrusions, conforming to the textured topography of the countersurface.

23. A wear engagement system comprising:
a polymeric surface comprising a poly(tetramethyl-p-silphenylenesiloxane) (PTMPS) polymer; and
a modified countersurface engaging the polymeric surface at a pressure of from 1 MPa to 10 MPa, a velocity of 200 mm/s to 2000 mm/s, and a contact radius of about 80 mm for a sliding distance of about 0.5 m/rev,
wherein the modified countersurface comprises an original countersurface of a disk and a transfer layer formed of particles shed from the polymeric surface comprising particles of the PTMPS polymer during an initial wear period of the wear engagement system.

24. An article comprising:
a polymer block comprising a poly(tetramethyl-p-silphenylenesiloxane) (PTMPS) polymer with repeat units of the following general Formula 3: 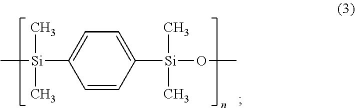
a wear track along a direction of wear track on a surface of the polymer block after the article is subject to a block-on-disk test against a countersurface of a disk at a pressure of from 1 MPa to 10 MPa, a velocity of 200 mm/s to 2000 mm/s, and a contact radius of about 80 mm for a sliding distance of about 0.5 m/rev; and
worn PTMPS polymer particles substantially along the sides of the wear track in a direction perpendicular to the direction of wear track;
wherein n is any integer from 5 to 50,000;
wherein the wear track is formed by the countersurface of the disk engaging the surface of the polymer block along the direction of wear track.

25. The article of claim 24, wherein the worn PTMPS polymer particles along the sides of the wear track do not agglomerate.

26. The article of claim 24,
wherein the surface of the polymer block further comprises a wear pattern spanning at least a portion of the wear track, the wear pattern defining a direction of wear pattern;
wherein the direction of wear pattern is substantially perpendicular to the direction of wear track.

27. A method of modifying a countersurface, the method comprising:
disposing an unmodified countersurface to frictionally engage a surface of a polymer block comprising a poly(tetramethyl-p-silphenylenesiloxane) (PTMPS) polymer;
transferring a plurality of PTMPS polymer particles from the surface of the polymer block to the countersurface during a frictional engagement; and
modifying the countersurface to include an engaged transfer layer of the transferred PTMPS polymer particles fixedly deposited on the unmodified countersurface.

28. The method of claim 27, wherein the unmodified countersurface presents a first coefficient of friction and the modified countersurface presents a second coefficient of friction, the second coefficient of friction being less than the first coefficient of friction.

29. The polymer composition of claim 13, wherein the PTMPS polymer comprises repeat units of the following general Formula 3: 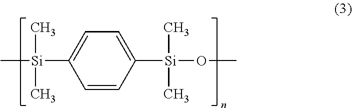
wherein n is any integer from 5 to 50,000.

30. The polymer composition of claim 17, wherein the PTMPS polymer comprises repeat units of the following general Formula 3: 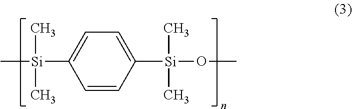
wherein n is any integer from 5 to 50,000.

31. The wear engagement system of claim 23, wherein the PTMPS polymer comprises repeat units of the following general Formula 3: 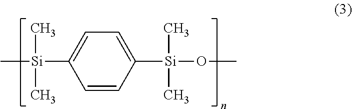
wherein n is any integer from 5 to 50,000.

32. The method of claim 27, wherein the PTMPS polymer comprises repeat units of the following general Formula 3: 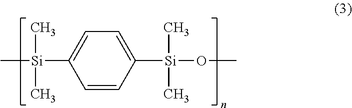
wherein n is any integer from 5 to 50,000.
